(19) United States
(12) Patent Application Publication
(10) Pub. No.: US 2012/0254555 A1
(43) Pub. Date: Oct. 4, 2012

(54) COMPUTER SYSTEM AND DATA MANAGEMENT METHOD

(75) Inventors: Shusaku Miwa, Odawara (JP); Nobuyuki Saika, Yokosuka (JP)

(73) Assignee: Hitachi, Ltd.

(21) Appl. No.: 13/125,287

(22) PCT Filed: Mar. 31, 2011
(86) PCT No.: PCT/JP2011/001945

§ 371 Date: Apr. 20, 2011

(51) Int. Cl. G06F 12/00

(52) U.S. Cl. 711/154; 711/E12.001

(57) ABSTRACT

The storage apparatus comprises a storage unit for storing data to be read and written by the host computer; and a control unit for controlling the writing of data into the storage unit, wherein the control unit deletes an entity of the data replicated to the archive apparatus from the storage unit and stubs the data; calls the stubbed data from the archive apparatus and temporarily stores the entity of the data according to a request from the host apparatus; and if an area where the entity of the stubbed data is stored in the storage unit among data storage areas of the storage unit is a predetermined capacity or less, migrates stub information concerning the stubbed data to a storage unit of another storage apparatus.

### TECHNICAL FIELD

The present invention relates to a computer system and a data management method and, for example, can be suitably applied to a computer system which comprises a storage apparatus and an archive apparatus.

### BACKGROUND ART

Conventionally, as one of the functions of the storage system, a data management function of migrating file data which a client/host stored in a logical volume to another storage apparatus such as an archive apparatus is disclosed (e.g. Patent Literature 1). In Patent Literature 1, the file data stored in the storage apparatus is migrated to the other storage apparatus in accordance with a predetermined policy which is determined in advance (e.g. a conditional expression based on a reference frequency and others).

Furthermore, in the foregoing migration, the file data migrated from the migration source storage apparatus to the migration destination storage apparatus is replaced by meta-information which indicates the storage location of the migration destination storage apparatus referred to as a stub file in the migration source storage apparatus. Subsequently, if the file data migrated to the other storage apparatus is requested by the client/host, the storage apparatus acquires the relevant file data from the other storage apparatus and transfers the same to the client/host. Here, the storage apparatus acquires the corresponding file data in the other storage apparatus in accordance with address information included in the stub file. By this method, [the storage apparatus] conceals from the client/host that the storage location of the file data was changed, and behaves as if the stub file were an entity file. This type of behavior is referred to as recall processing.

Furthermore, in Patent Literature 2, it is disclosed that the foregoing file data migration is performed in the hierarchized storage system which comprises a plurality of types of hard disk devices of different performances. In this hierarchized storage system, in accordance with the access frequency and others, the file data is migrated to the hard disk devices of different hierarchies. For example, it is possible to perform storage management efficiently by storing file data whose access frequency is high in a high-performance storage hierarchy and storing file data whose access frequency is low in a low-performance storage hierarchy.

### CITATION LIST

### Patent Literature

PTL 1: Japanese Patent Application Laid-Open (Kokai) No. 2006-1642211
PTL 2: Japanese Patent Application Laid-Open (Kokai) No. 2009-289252

### SUMMARY OF INVENTION

### Technical Problem

The file data acquired by the foregoing recall processing from the other storage apparatus which is the migration destination is temporarily stored in the logical volume of the storage apparatus. Therefore, in one storage apparatus, the recall processing and the access processing for the recalled file are performed. For example, if the recall processing occurs frequently as in the case where the client/host performs file search processing by using a keyword included in the file data and in other cases, there is a problem in that the response performance for the client/host is deteriorated.

The present invention was devised in view of the foregoing problem, and its object is to propose apresenting computer system and a data management method capable of improving the access performance by reducing the load on the storage apparatus caused by the recall processing.

### Solution to Problem

In order to achieve the foregoing object, the present invention provides a computer system in which a plurality of storage apparatuses, a host apparatus which requests writing of data to the plurality of storage apparatuses, and a plurality of archive apparatuses which replicate data stored in the plurality of storage apparatuses according to the request of the plurality of storage apparatuses are respectively and mutually connected via a network, wherein the storage apparatus comprises a storage unit for storing data to be read and written by the host computer; and a control unit for controlling the writing of data into the storage unit, wherein the control unit deletes an entity of the data replicated to the archive apparatus from the storage unit and stubs the data; calls the stubbed data from the archive apparatus and temporarily stores the entity of the data according to a request from the host apparatus; and if an area where the entity of the stubbed data is stored in the storage unit among data storage areas of the storage unit is a predetermined capacity or less, migrates stub information concerning the stubbed data to a storage unit of another storage apparatus.

According to such configuration, the storage apparatus deletes an entity of the data replicated to the archive apparatus from the storage unit and stubs the data; calls the stubbed data from the archive apparatus and temporarily stores the entity of the data according to a request from the host apparatus. Subsequently, if an area where the entity of the stubbed data is stored in the storage unit among data storage areas of the storage unit is a predetermined capacity or less, the storage apparatus migrates stub information concerning the stubbed data to a storage unit of another storage apparatus. According to this method, by the recall processing of calling the stubbed data from the archive apparatus, it is possible to prevent the deterioration of the cache function of the storage apparatus and improve the access performance of the storage apparatus.

### Advantageous Effects of Invention

According to the present invention, by reducing the load on the storage apparatus due to the recall processing, the access performance can be improved.

### BRIEF DESCRIPTION OF DRAWINGS

FIG. 1 is a conceptual diagram explaining the overview of a first embodiment of the present invention.

FIG. 2 is a block diagram showing the entire configuration of the computer system related to the first embodiment.

FIG. 3 is a block diagram showing the configuration of a disk array apparatus related to the first embodiment.

FIG. 4 is a block diagram showing the software configuration of the computer system related to the first embodiment.

FIG. 5 is a conceptual diagram showing the configuration of the file system related to the first embodiment.

FIG. 6 is a table showing the contents of an inode management table related to the first embodiment.

FIG. 7 is a conceptual diagram showing an example of reference to data blocks by inodes related to the first embodiment.

FIG. 8 is a conceptual diagram showing the details of the inode management table related to the first embodiment.

FIG. 9 is a table showing the contents of a file list related to the first embodiment.

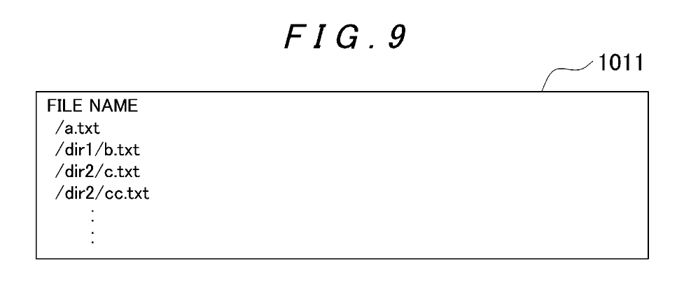

FIG. 10 is a table showing the contents of an update list related to the first embodiment.

FIG. 11 is a table showing the contents of a stub list related to the first embodiment.

FIG. 12 is a table showing the contents of a recall list related to the first embodiment.

FIG. 13 is a table showing the contents of a file management table related to the first embodiment.

FIG. 14 is a conceptual diagram explaining the file reference processing related to the first embodiment.

FIG. 15 is a table showing the contents of an Edge node management table related to the first embodiment.

FIG. 16 is a table showing the contents of a Core node management table related to the first embodiment.

FIG. 17 is a conceptual diagram explaining the processing contents of monitoring processing related to the first embodiment.

FIG. 18 is a conceptual diagram explaining the processing contents of file system addition processing related to the first embodiment.

FIG. 19 is a table showing the updated contents of the file management table related to the first embodiment.

FIG. 20 is a conceptual diagram explaining the processing contents of Edge node addition processing related to the first embodiment.

FIG. 21 is a table showing the updated contents of the file management table related to the first embodiment.

FIG. 22 is a conceptual diagram explaining the processing contents of Core node addition processing related to the first embodiment.

FIG. 23 is a table showing the contents of a data packet related to the first embodiment.

FIG. 24 is a conceptual diagram explaining the problem of the recall processing related to the first embodiment.

FIG. 25 is a conceptual diagram explaining Core node addition related to the first embodiment.

FIG. 26 is a table showing an example of changing a policy related to the first embodiment.

FIG. 27 is a conceptual diagram explaining the process of adding nodes related to the first embodiment.

FIG. 28 is a block diagram showing the programs in the storage apparatus and the archive apparatus related to the first embodiment.

FIG. 29A is a flowchart showing the processing contents of data migration processing in the storage apparatus related to the first embodiment.

FIG. 29B is a flowchart showing the processing contents of data migration processing in the storage apparatus related to the first embodiment.

FIG. 30 is a flowchart showing the processing contents of data migration processing in the archive apparatus related to the first embodiment.

FIG. 31A is a flowchart showing the processing contents of read/write acceptance processing of the storage apparatus related to the first embodiment.

FIG. 31B is a flowchart showing the processing contents of read/write acceptance processing of the storage apparatus related to the first embodiment.

FIG. 32 is a flowchart showing the processing contents of the monitoring processing of the storage apparatus related to the first embodiment.

FIG. 33 is a flowchart showing the processing contents of the monitoring processing of the archive apparatus related to the first embodiment.

FIG. 34 is a conceptual diagram explaining the overview of a second embodiment of the present invention.

FIG. 35A is a flowchart showing the processing contents of the data migration processing of the storage apparatus related to the second embodiment.

FIG. 35B is a flowchart showing the processing contents of the data migration processing of the storage apparatus related to the second embodiment.

### DESCRIPTION OF EMBODIMENTS

The embodiments of the present invention are now described in detail with reference to the drawings.

### (1) First Embodiment

### (1-1) Overview of this Embodiment

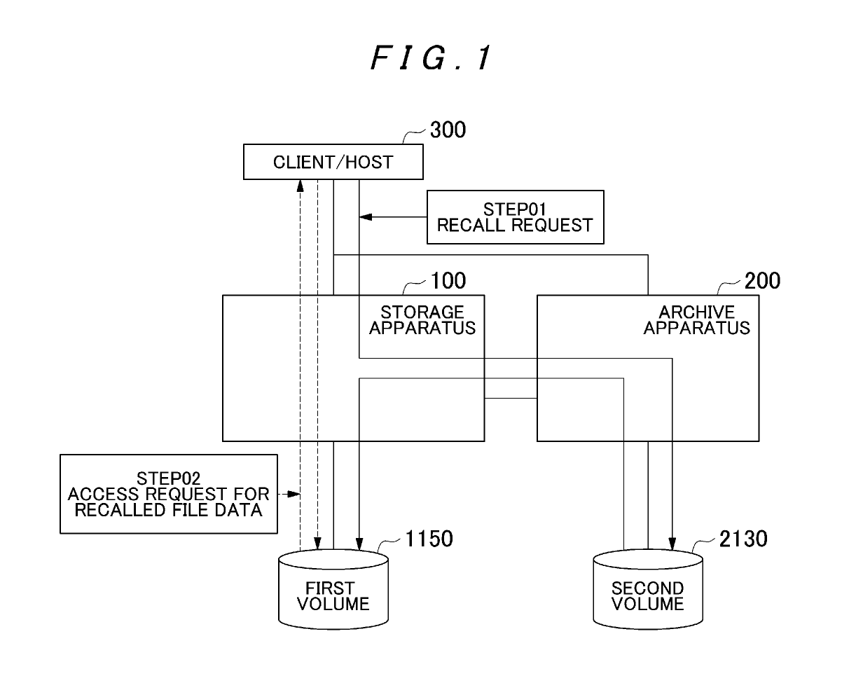

As shown in FIG. 1, conventionally, as one of the functions of a storage apparatus 100, migration of the file data stored in the logical volume by a client/host 300 to an archive apparatus 200 is performed. For example, the file data stored in the storage apparatus 100 is migrated to the archive apparatus 200 in accordance with the predetermined policy which is determined in advance (e.g. a conditional expression based on a reference frequency and others).

Furthermore, in the foregoing migration, the file data migrated from the storage apparatus 100 to the archive apparatus 200 is replaced by meta-information referred to as a stub file which indicates the storage location in the archive apparatus 200 in the storage apparatus 1000. Subsequently, if the file data migrated to the archive apparatus 200 is requested by the client/host 300, the storage apparatus 100 acquires the relevant file data from the archive apparatus 200 and transfers the same to the client/host 300.

Here, the storage apparatus 100 acquires the corresponding file data in the archive apparatus 200 in accordance with address information included in the stub file. By this method, [the storage apparatus] conceals from the client/host 300 that the storage location of the file data was changed, and behaves as if the stub file were an entity file. This type of behavior is referred to as recall processing. The file data acquired by the foregoing recall processing from the archive apparatus 200 which is the migration destination is temporarily stored in a logical volume of the storage apparatus 100.

For example, let it be assumed that the file data stored in a first volume 1150 of the storage apparatus 100 has been migrated to a second volume 2130 of the archive apparatus 200. In this case, if a recall request is made from the client/host 300 (STEP 01), the storage apparatus 100 performs the recall request for the file data requested by the client/host 300. Subsequently, [the storage apparatus 100] acquires the corresponding file data from the second volume 2130 of the archive apparatus 200, and stores the same in the first volume 1150 of the storage apparatus 100. The file data recalled in the storage apparatus 100 is temporarily stored in the first volume 1150 of the storage apparatus 100 as long as the capacity and the policy of the storage apparatus 100 allow. Hereinafter, being temporarily stored in an arbitrary volume of the storage apparatus 100 may also be explained as “being cached.”

Meanwhile, if an access request for the recalled file data is made from the client/host 300 (STEP 02), the storage apparatus 100 acquires the file data temporarily stored in the first volume. For example, in the case where the client/host 300 performs the file search by the keyword search included in the file data, the recall processing will occur in the storage apparatus 100 frequently. As explained above, since the recall processing and the cache access processing are performed for the storage apparatus 100, if the recall processing increases, the cache access processing is affected, which deteriorates the response performance for the client/host 300 which made the cache access request.

Therefore, in this embodiment, if the recall processing occurs frequently in the storage apparatus 100, the access performance of the entire system is improved by newly adding file systems, storage apparatuses, and others and thereby reducing the processing load.

### (1-2) Hardware Configuration of Computer System

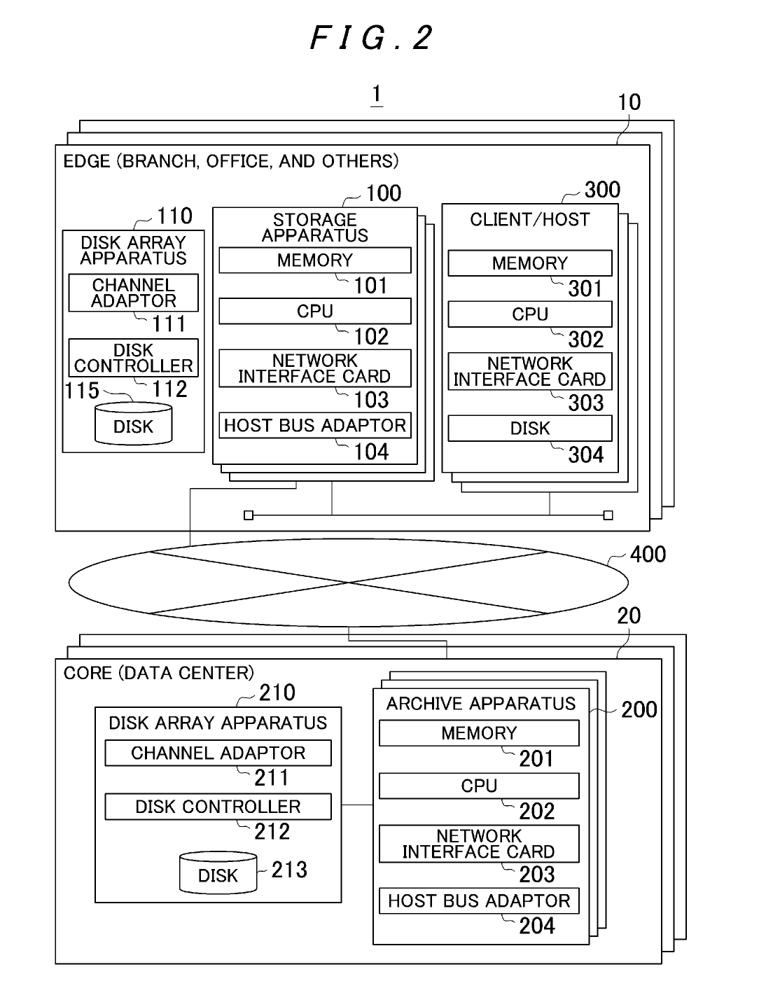

Next, the hardware configuration of the computer system 1 is explained. As shown in FIG. 2, the computer system 1 is mainly configured of an Edge 10 comprising the storage apparatus 100 which provides files to the client/host 300 and a disk array apparatus 110 which controls writing of data to a disk 115 and others, and a Core 20 comprising a plurality of archive apparatuses 200 and a disk array apparatus 210. The Edge 10 and the Core 20 may also be configured of a plurality of Edges 10 and Cores 20, respectively.

Furthermore, in this embodiment, the bases such as branches and offices where the user actually performs business are collectively referred to as the Edge 10, and the bases where the servers and storage apparatuses used by the companies and others are integratedly managed and the data centers where cloud service is provided are collectively referred to as the Core 20.

The Edge 10 and the Core 20 are connected via a network 400. The network 400 is configured of SAN (Storage Area Network) and others for example, and communication between the apparatuses is performed in accordance with the Fibre Channel protocol for example. Furthermore, the network 400 may also be LAN (Local Area Network), the Internet, a public telecommunication network, exclusive lines or others. If the network 400 is LAN, communication between the apparatuses is performed in accordance with the protocols of TCP/IP (Transmission Control Protocol/Internet Protocol) for example.

As explained above, the Edge 10 is configured of the disk array apparatus 110, the storage apparatus 100, the client/host 300, and others. Though the storage apparatus 100 and the disk array apparatus 110 are separately configured in this embodiment, the configuration is not limited thereto, and the storage apparatus 100 and the disk array apparatus 110 may also be configured integratedly as a storage apparatus.

The storage apparatus 100 comprises a memory 222, a CPU 224, a network interface card (NIC: Network Inter Face Card) 226, a host bus adapter (HBA: Host Bus Adapter) 228, and others.

The CPU 102 functions as an operational processing unit, and controls the operation of the storage apparatus 100 in accordance with the programs and the operational parameters stored in the memory 101. The network interface card 103 is an interface for the communication with the archive apparatus 320 via the network 400. Furthermore, the host bus adapter 104 connects the disk array apparatus 110 and the storage apparatus 100, and the storage apparatus 100 performs accesses in units of blocks for the disk array apparatus 210 via the host bus adapter 104. In the explanation below, the storage apparatus 100 may be explained by being referred to as an Edge node.

The disk array apparatus 110 comprises a channel adapter (CHA: Channel Adapter) 111, a disk controller (DKC: Disk Controller) 112, a disk 115, and others. The channel adapter 111 comprises a function of receiving data input/output requests transmitted from the host bus adapter 104. Furthermore, the disk controller 212 comprises a function of controlling input/output to/from the disk 115 in accordance with the input/output requests received by the channel adapter 111.

Though the disk array apparatus 110 comprises one disk 115 in FIG. 2, the configuration is not limited thereto, and a plurality of disks 115 may also be provided. Furthermore, [the disks] may also be configured of a plurality of hard disk drives (HDD: Hard Disk Drives) comprised of, for example, expensive hard disk drives such as SSD (Solid State Disk) and SCSI (Small Computer System Interface) disks or inexpensive hard disk drives such as SATA (Serial AT Attachment) disks. Hereinafter, the disk 115 may also be referred to as a hard disk device 115 or an HDD 115.

The client/host 300 comprises a memory 301, a CPU 302, a network interface card (NIC (Network Interface Card) 303, a disk 304, and others.

The CPU 302 functions as an operational processing unit, reads a program such as the OS stored in the disk 304 which controls the client/host 300 to the memory 301, and performs the relevant program. Furthermore, the network interface card 303 communicates with the storage apparatus 100 connected via the network, and performs the accesses in units of files.

Furthermore, the archive apparatus 200 comprises a memory 201, a CPU 202, a network interface card (NIC: Network Interface Card) 303, a host adapter (HBA: Host Bus Adapter) 204, and others.

The CPU 202 functions as an operational processing unit, and controls the operation of the archive apparatus 200 in accordance with the programs, the operational parameters and others stored in the memory 201. The network interface card 303 is an interface for the communication with the storage apparatus 100 via the network 400. Furthermore, the host bus adapter 204 connects the disk array apparatus 210 and the archive apparatus 200, and the archive apparatus 200 performs accesses in units of blocks for the disk array apparatus 210 via the host adapter 204

The disk array apparatus 210 comprises a channel adapter (CHA) 211, a disk controller (DKC) 212, a disk 213, and others. The channel adapter 211 comprises a function of receiving data input/output requests transmitted from the host adapter 204. Furthermore, the disk controller 212 comprises a function of controlling input/output to/from the disk 213 in accordance with the input/output requests received by the channel adapter 211.

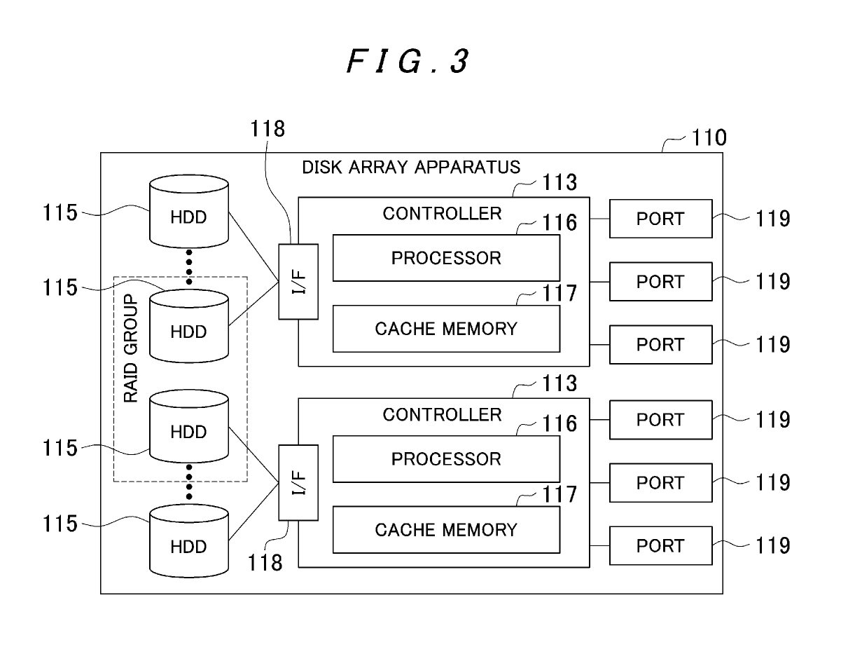

Next, the RAID (Redundant Arrays of Independent Disks) system in the disk array apparatus 110 is explained. As shown in FIG. 3, the disk array apparatus 110 is configured of a plurality of hard disk devices 115 (referred to as disks in the drawings), a plurality of controllers 113, a plurality of ports (referred to as Ports in the drawings) 119, and a plurality of interfaces (referred to as I/Fs in the drawings) 118.

The controller 113 is configured of a processor 116 which controls data input/output and a cache memory 117 which temporarily stores the data. Furthermore, the port 119 is an interface board for the channel, and functions as what is called a channel adapter (CHA) which connects the controller 113 and the storage apparatus 100. The port 119 comprises a function of transferring commands received from the storage apparatus 100 via a local router (not shown in the drawings) to the controller 113.

Furthermore, the interface 118 is an interface board for the hard disk, and comprises a function as a disk adapter (DKA). The interface 118 performs the transfer of the data of the commands issued to the hard disk device 115 via the local router (not shown in the drawings). Furthermore, it is also possible to connect the controller 113, the interface 118, and the port 119 mutually by switches (not shown in the drawings) and distribute the data of the commands and others.

Furthermore, one or more logical volumes (LDEVs) are set in the storage area provided by the plurality of hard disk devices 115. The plurality of hard disk drives 115 are managed as one RAID group, and one or more logical volumes are defined in the storage area provided by the RAID group. Subsequently, the logical volumes provided by a plurality of RAID groups are managed as one pool. Normally, in creating a logical volume, the storage area in the hard disk is assigned to the logical volume, but the assigned storage area is not utilized efficiently if the usage frequency by the host (user) to the logical volume that the storage area is assigned to is low. Therefore, the Thin Provisioning function in which the storage area in the hard disk is not assigned until a data write request from the host (user) is accepted is utilized for the first time.

By Thin Provisioning, a virtual volume (hereinafter referred to as a virtual volume) is presented to the client/host 300 and, if a write access is made from the client/host 300 to the virtual volume, a physical storage area for actually storing the data is assigned to the virtual volume. By this method, while presenting the volume of the capacity equal to or larger than the storage area in the storage apparatus 100 to the client/host 300, the storage area in the storage apparatus 100 can be utilized efficiently.

### (1-3) Software Configuration of Computer System

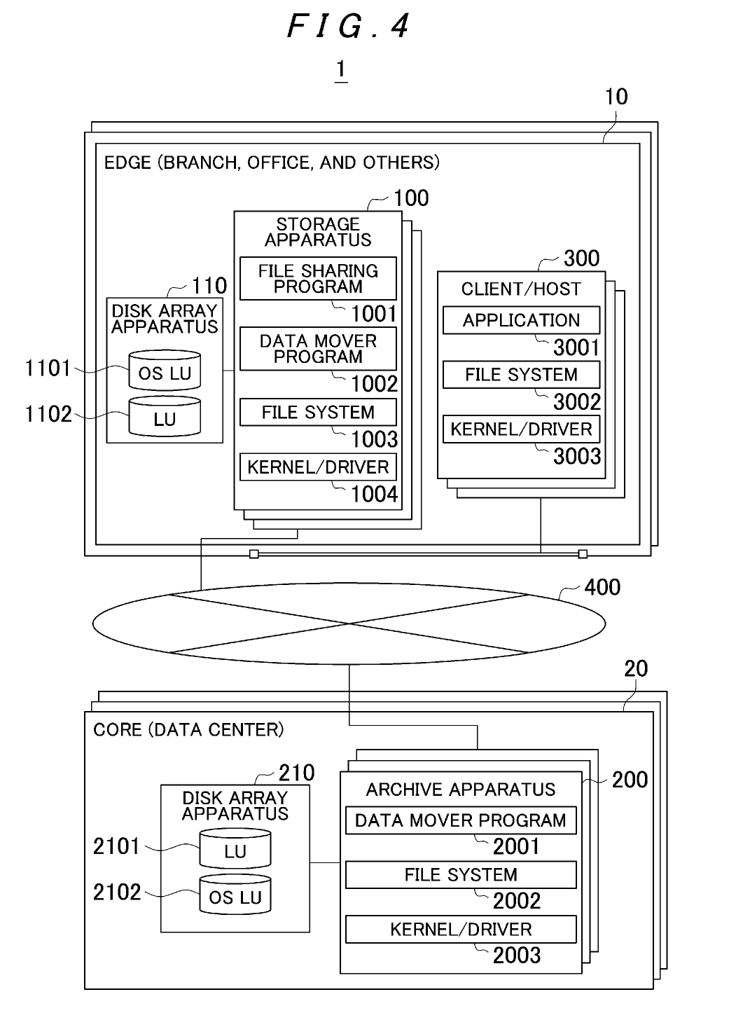

Next, the software configuration of the computer system 1 is explained. As shown in FIG. 4, in the memory 101 of the storage apparatus 100, a file sharing program 1001, a data mover program 1002, a file system 1003, and a kernel/driver 1004 are stored.

The file sharing program 1001 is a program which provides a file sharing system for the client/host 300 by utilizing communication protocols such as CIFS (Common Internet File System) and NFS (Network File System).

The data mover program 1002 is a program which, in migrating data, transmits the migration target data from the storage apparatus 100 as the migration source to the archive apparatus 200 as the migration destination. Meanwhile, the data mover program 1002 comprises a function of acquiring data via the archive apparatus 200 if accepting a reference request from the client/host 300 for the data which is already migrated to the archive apparatus 200.

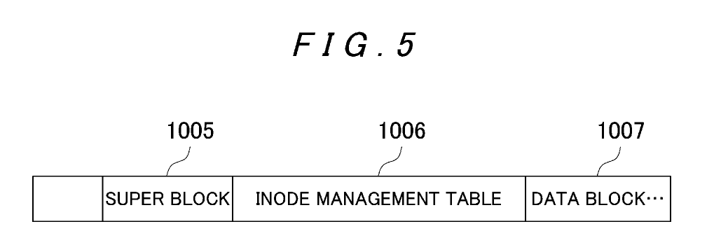

The file system 1003 is a program which manages the logical configuration which is structured for realizing a management unit as a file in the logical volume. The file system managed by the file system 1003 is configured of a super block 1005, an inode management table 1006, a data block 1007, and others as shown in FIG. 5.

The super block 1005 is an area integratedly retaining the information of the entire file system. The information of the entire file system is, for example, the size of the file system, the free capacity of the file system, and others.

The inode management table 1006 is a table for managing the inodes which are made to correspond to one directory or file. The data block 1007 is a block in which actual file data, management data, and others are stored.

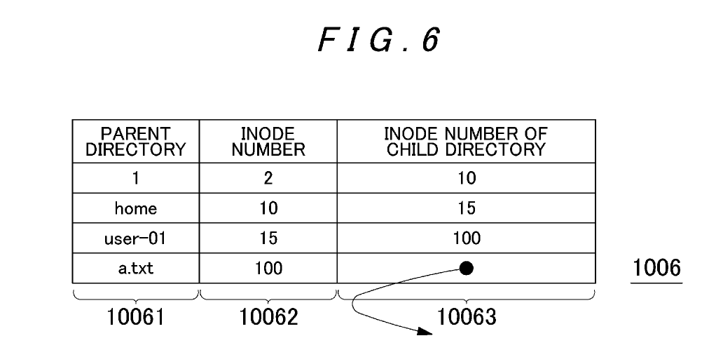

For accessing an inode in which a file is stored, directory entries including directory information only are used. For example, for accessing a file which is defined as “home/user-01/a.txt”, as shown in FIG. 6, the data block is accessed by tracking the inode numbers made to correspond to the directories. Specifically, by tracking the inode numbers as “2-10-15-100”, it is possible to access the data block which is “a.txt”.

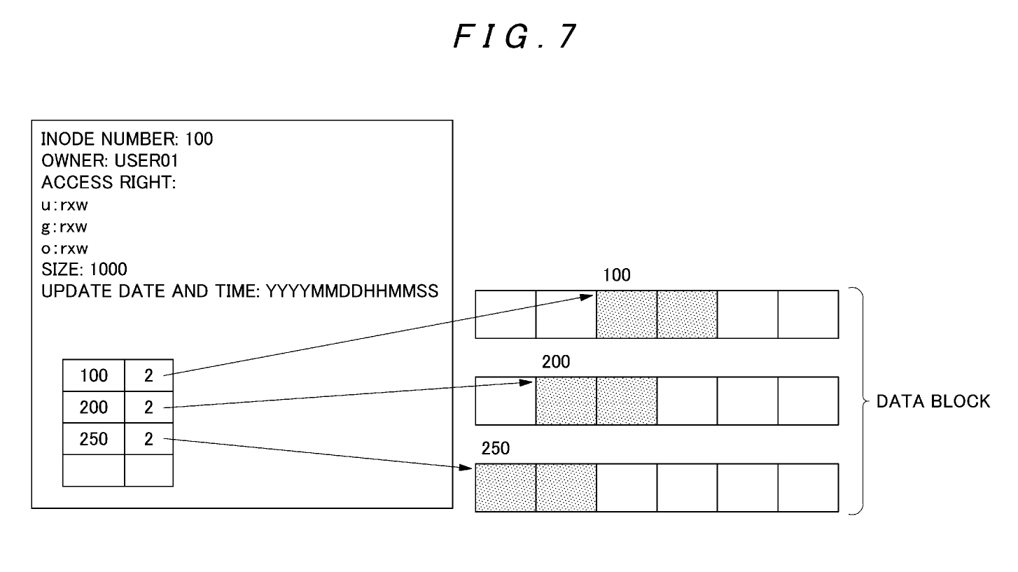

In the inode made to correspond to the entity of the file “a.txt”, as shown in FIG. 7, information such as the file ownership, the access right, the file size, and the data storage location is stored. Here, the reference relationship between the inodes and the data blocks is explained. As shown in FIG. 7, “100”, “200”, and “250” in the drawings indicate block addresses. Furthermore, “2”, “2”, and “2” which are made to correspond to the block addresses indicate the numbers of blocks from the relevant addresses. In the areas indicated by these numbers of blocks, the data is stored.

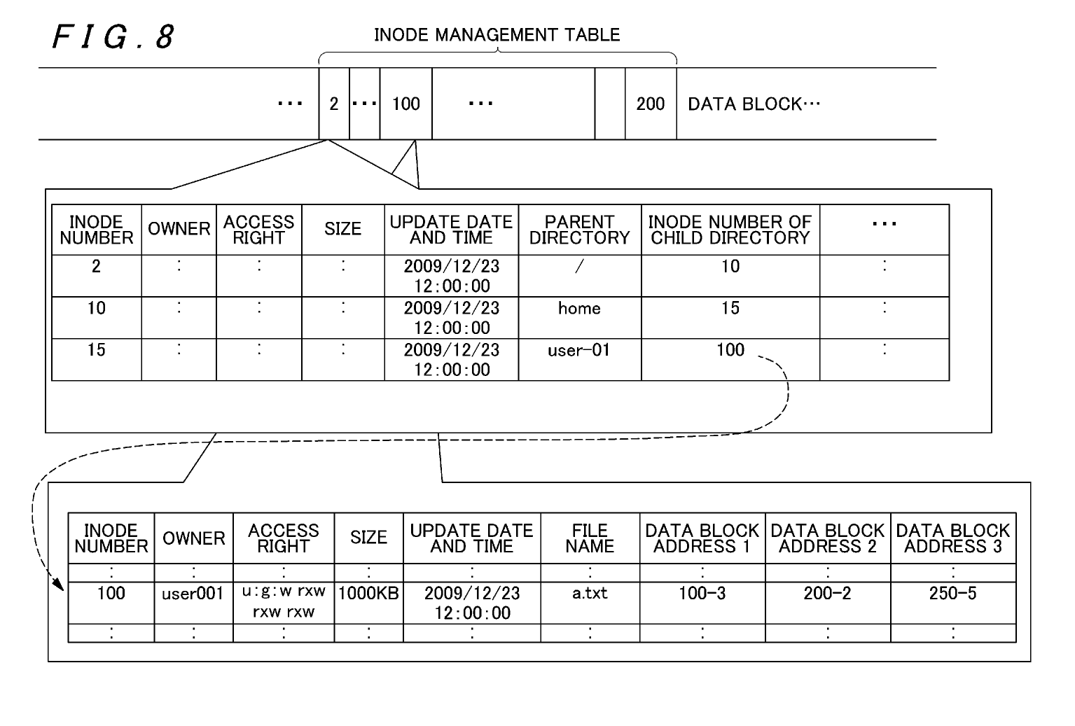

Furthermore, this inode is stored in the inode management table as shown in FIG. 8. Specifically, in the inode which is made to correspond to a directory only, the inode number, the update date and time, and the inode numbers of the parent directory and the child directory are stored. Subsequently, in the inode made to correspond to the entity of the file, in addition to the inode number, the update date and time, the parent directory and the child directory, information such as the owner, the access right, the file size, and the data block address is stored.

Returning to FIG. 4, the kernel/driver 1004 of the storage apparatus 100 is a program which performs the general control of the storage apparatus 100 and the control unique to the hardware. Specifically, [the kernel/driver 1004] performs the control of the schedule of a plurality of programs operating in the storage apparatus 100, the control of interruptions from the hardware, the input/output in units of blocks to/from the storage device, and others.

In the memory 301 of the client/host 300, an application 3001, a file system 3002, a kernel/driver 3003, and others are stored. The application 3001 is various types of application programs performed in the client/host 300. As the file system 3002 comprises the same function as the foregoing file system 1003 of the storage apparatus 100, the detailed explanation thereof is omitted. Furthermore, as the kernel/driver 3003 comprises the same function as the foregoing kernel/driver 1004, the detailed explanation thereof is omitted.

In the disk 115 of the disk array apparatus 110, a logical volume (referred to as an OS LU in the drawings) 1101 for storing the OS such as a control program and a logical volume (referred to as an LU in the drawings) 1102 for storing data is stored. The control program stored in the OS LU 1101 can, for example, illustrate a program which provides the Thin Provisioning function to the client/host 300. The relevant program manages the logical volumes defined in the RAID group configured of a plurality of hard disks as one pool. In addition, [the program] comprises a function of providing a virtual volume to the client/host 300 and, if a write access is made from the client/host 300, assigning an area of the pool to the virtual volume.

Furthermore, in the archive apparatus 200 of the Core 20, a data mover program 2001, a file system 2002, and a kernel/driver 2003 are stored. As the data mover program 2001 comprises the same function as the data mover program 1002 of the storage apparatus 100, the detailed explanation thereof is omitted. Furthermore, as the file system 2002 comprises the same function as the file system 1003 of the storage apparatus 100, the detailed explanation thereof is omitted. Furthermore, as the kernel/driver 2003 comprises the same function as the kernel/driver 1004 of the storage apparatus 100, the detailed explanation thereof is omitted.

Furthermore, as the disk array apparatus 210 of the Core 20 comprises nearly the same function as the disk array apparatus 110 of the Edge 10, the detailed explanation thereof is omitted.

### (1-4) Overview of Processing by Computer System

Firstly, the preconditions for the data management processing related to this embodiment to be performed are explained.

(Precondition 1)

The files are asynchronously replicated between the storage apparatus 100 of the Edge node 10 and the archive apparatus 200 of the Core node 20. Here, replication indicates storing a replication (replica) of exactly the same contents as the data stored in the storage apparatus 100 in another apparatus, and synchronizing the contents thereof. The files to be the replication target are described in a file list 1011 included in a replication request transmitted from a management terminal (not shown in the drawings) in accordance with the input by the administrator. The file list 1011 is stored in the memory 101 of the storage apparatus 100.

The file list 1011 is a list in which the file names to be the replication target are stored, and a list of the file names such as “/a.txt” and “/dir1/b.txt” which are the file names which are the replication target is stored.

The storage apparatus 100 refers to the file names stored in the file list 1011, transfers the files stored in the logical volume 1102 of the disk array apparatus 110 to the archive apparatus 200, and performs the replication processing for the files.

(Precondition 2)

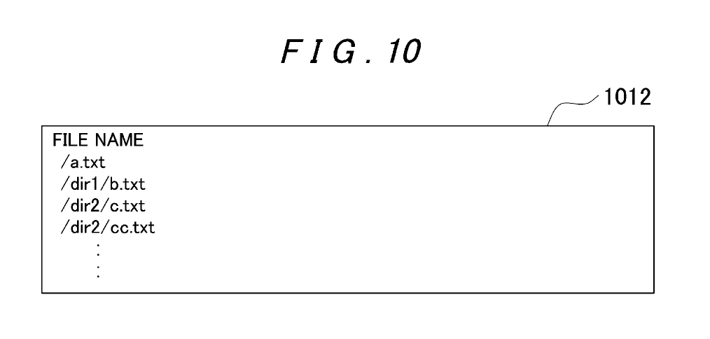

Furthermore, after a file stored in the storage apparatus 100 is replicated, if the relevant file is updated, the storage apparatus 100 transfers the updated file to the archive apparatus 200 again. The archive apparatus 200 updates the file in accordance with the transmitted updated file, and performs the synchronization processing. If the file is updated after the replication, the file name is stored in an update list 1012. The update list 1012 is a list in which the names of the files updated after the replication is stored as shown in FIG. 10, and a list of the file names such as “/a.txt” and “/dir1/b.txt” is stored. The update list 1012 is stored in the memory 101 of the storage apparatus 100.

If a file is updated after being replicated, the file name is stored in the update list 1012. Subsequently, if the updated file is transferred from the storage apparatus 100 to the archive apparatus 200 and the synchronization is completed, the relevant file name is deleted from the update list 1012.

(Precondition 3)

Next, if the first precondition is satisfied, that is, if the remaining capacity of the file system of the Edge node 10 reaches a predetermined threshold or in other cases, the foregoing replicated file is made a migration candidate. For example, if a file stored in the file list 1011 is replicated, the relevant file is made a migration candidate.

(Precondition 4)

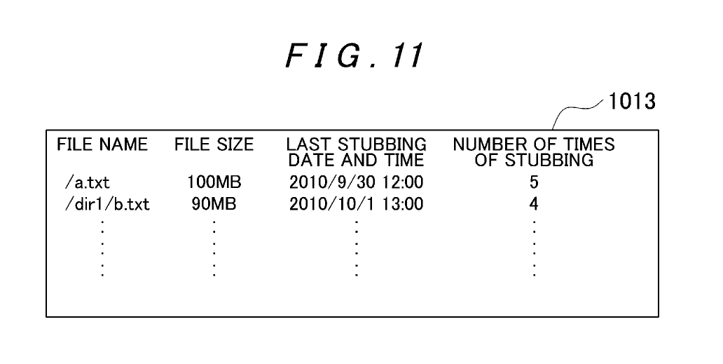

If any of the foregoing migration candidates satisfies the second condition, that is, if the last access date and time is older than a predetermined threshold or in other cases, the entity of the relevant file is deleted from the Edge node 10 and is stubbed. The stubbed files are managed in the stub list 1013. In the stub list 1013, as shown in FIG. 11, file names, file sizes, last stubbing dates and time, the number of stubbing, and others are stored. The stub list 1013 is stored in the memory 101 of the storage apparatus 100.

(Precondition 5)

Next, if a read request occurs from the client/host 300 for the stub in the Edge node 10 (storage apparatus 100) created according to the Precondition 4, the storage apparatus 100 performs the recall processing. Furthermore, if accepting a write request from the client/host 300, the storage apparatus 100 performs the recall processing and then overwrites the file. The file recalled by the storage apparatus 100 is managed in a recall list 1014. For the file overwritten after the recall processing, the synchronization processing is performed according to the Precondition 2. Specifically, the relevant file of the archive apparatus 200 of the Core node 20 is updated.

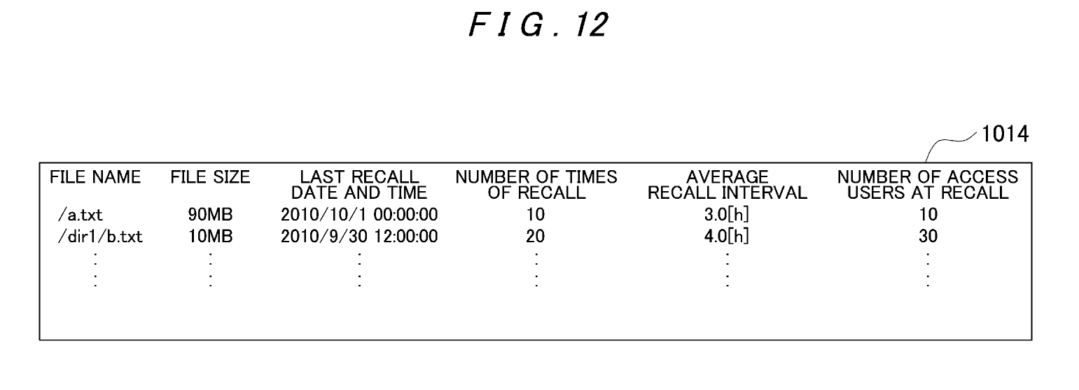

In the recall list 1014, as shown in FIG. 12, file names, file sizes, last recall dates and time, the number of times of recall, average recall intervals, numbers of access users at recall, and others are stored. The recall list 1014 is stored in the memory 101 of the storage apparatus 100.

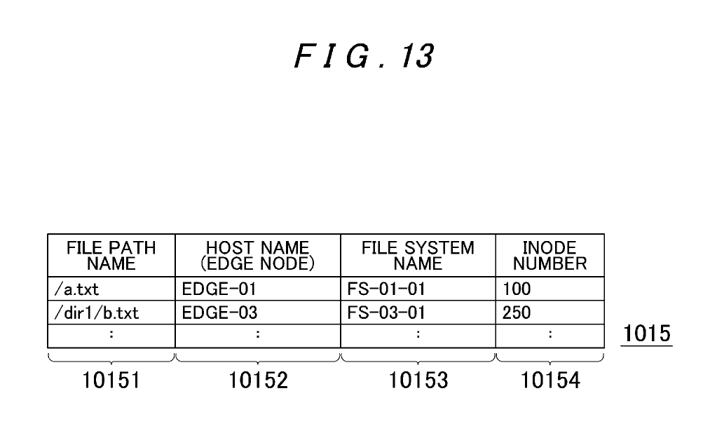

Next, the correspondence relationship between the directory configurations to which the user can refer and the storage locations of the files where the files are actually stored is explained. The correspondence relationship between the directory configurations and the storage locations of the files is managed by the file management table 1015. As shown in FIG. 13, the file management table 1015 is configured of a file path name field 10151, a host name (Edge node) field 10152, a file system name field 10153, and an inode number field 10154.

In the file path name field 10151, the path names of the files to which the user can refer are stored. In the host name (Edge node) field 10152, the names for identifying the hosts (clients/hosts 300) in which the files are stored are stored. Here, the host indicates an Edge node 10 including the client/host 300. In the file system name field 10153, the names for identifying the file systems are stored. In the inode number field 10154, the numbers for identifying the areas where the files are stored are stored.

By the file management table 1015, it is possible to make the file path names to which the user can refer correspond to the information of the storage locations where the files are actually stored. By this method, in case where the computer system 1 is configured including a plurality of Edge nodes 10, even if a file or stub is migrated between the plurality of Edge nodes or Core nodes, the names of the file paths to which the user refers are not changed. Therefore, the storage locations of the files and stubs in the storage apparatus 100 can be changed without changing the directory configuration as seen from the user.

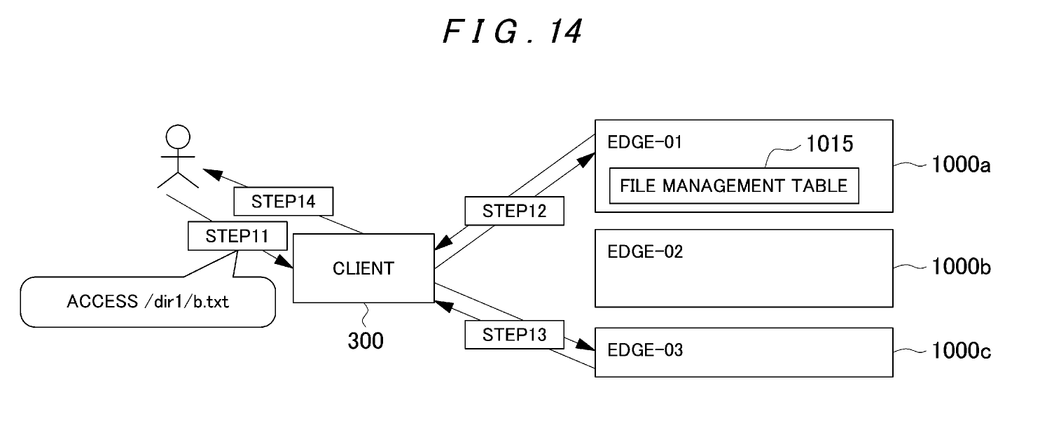

Next, the file reference processing by utilizing the file management table 1015 is explained. As shown in FIG. 14, firstly, the user accesses a file named “b.txt” by utilizing the client terminal and specifying a file path name “/dir1/b.txt” (STEP 11). Hereinafter, a plurality of Edge nodes 10 may be explained as an “edge-XX” and a plurality of Core nodes 20 may be explained as a “core-XX”. The client terminal refers to the file management table 1015 stored in an edge-01, and acquires the host name, file system name, and the inode number of the file which corresponds to the file path name “/dir1/b.txt” (STEP 12).

Subsequently, the client terminal accesses an edge-03 corresponding to the file system name acquired at STEP 12, and acquires the file corresponding to the file path name “/dir1/b.txt” (STEP 13). The client terminal provides the file acquired at STEP 13 to the user (STEP 14).

As explained above, even if a plurality of Edge nodes exist, if the file management table 1015 is stored in a specific Edge node and the user accesses a file stored in any of the Core nodes, the storage location of the actual file corresponding to the file path name can be identified. Therefore, even if a file or a stub is migrated between a plurality of Edge nodes, it becomes possible to provide the file desired by the user without changing the information to which the user refers.

Furthermore, it is also possible to prepare a plurality of Edge nodes 10 and Core nodes 20 in the computer system 1 in advance. The plurality of Edge nodes 10 prepared in the computer system 1 are managed by the Edge node management table 1016 and the plurality of Core nodes 20 are managed by the Core node management table 1017.

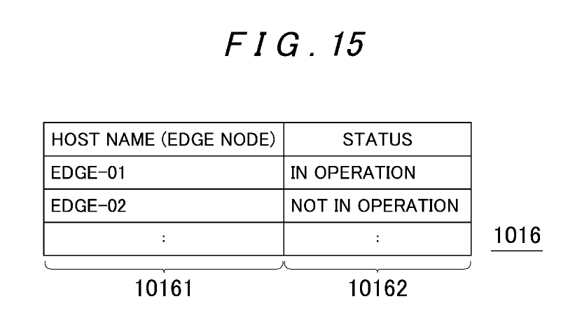

The Edge node management table 1016 is a table for managing the operational status of each of the Edge nodes 10, and is configured of a host name (Edge node) field 10161 and a status field 10162 as shown in FIG. 15. The information for identifying the Edge nodes is stored in the host name (Edge node) field 10161, and the information of the operational status such as whether each of the Edge nodes is in operation or not is stored in the status field 10162.

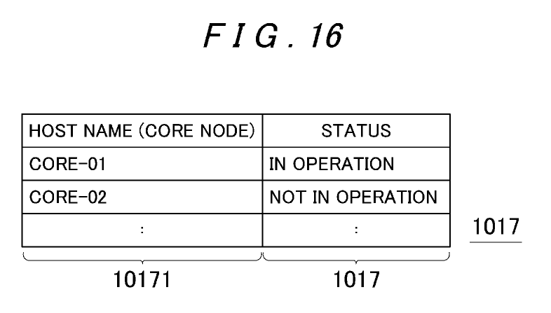

Furthermore, the Core node management table 1017 is a table for managing the operational status of each of the Core nodes 20, and is configured of a host name (Edge node) field 10171 and a status field 10172 as shown in FIG. 16. Information for identifying the Core nodes is stored in the host name (Edge node) field 10171, and information of the operational status such as whether each of the Core nodes is in operation or not is stored in the status field 10172.

Next, the overview of the processing of the computer system 1 is explained. The data management processing in the computer system 1 is mainly configured of the monitoring processing (STEP 100), the file system addition processing (STEP 200), the Edge node addition processing (STEP 300), and the Core node addition processing (STEP 400).

The monitoring processing (STEP 100) regularly ascertains the ratio between the size of the storage area which can be stored in the storage apparatus 100 and the size of the area utilized for storing the files in the archive apparatus 200 and the frequency of the occurrence of recalls, and monitors whether the size ratio and the recall frequency are within the predetermined thresholds or not.

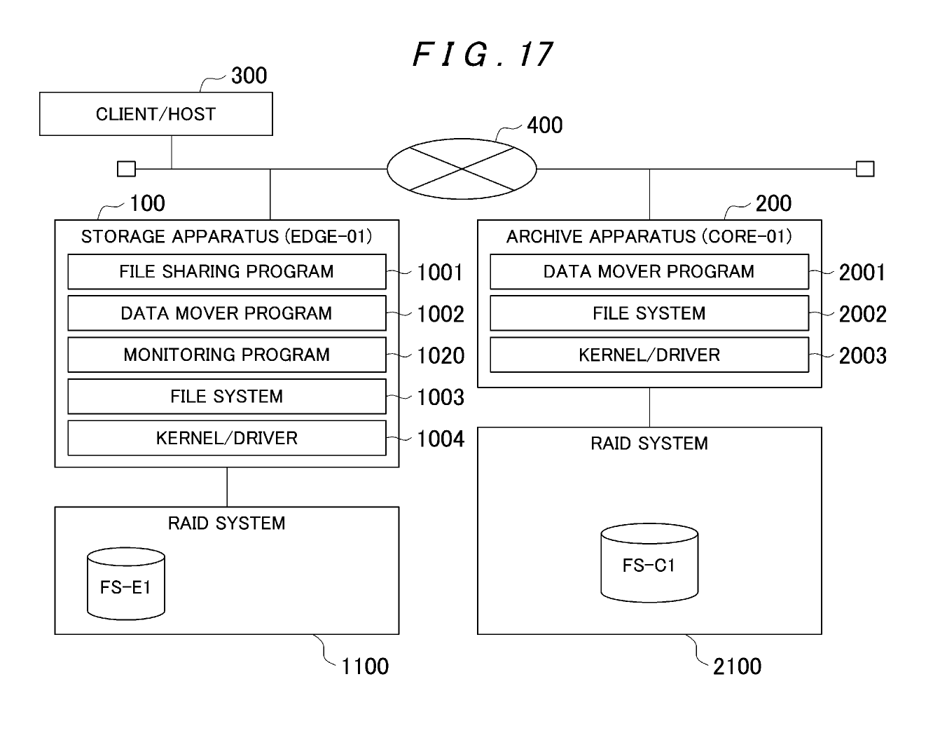

As shown in FIG. 17, in the memory 101 of the storage apparatus 100 of the edge-01, a monitoring program 1020 is stored in addition to the foregoing programs. Furthermore, in the RAID system 1100 of the disk array apparatus 110, a file system FS-E1 is defined. Furthermore, in the RAID system 2100 of the disk array apparatus 210 connected to the archive apparatus 200 of the core-02, a file system FS-C1 is defined.

The monitoring program 1020 monitors the ratio between the size of the storage area of the file system FS-E1 in the edge-01 and the size of the used area of the file system FS-C1 in the core-01 and the recall frequency. Subsequently, if the relevant ratio or recall frequency exceeds a predetermined threshold, [the program] determines that a new file system must be added. For example, if the relevant ratio exceeds the predetermined threshold, only an extremely small part of the recalled files are stored in the file system FS-E1 in the edge-01. Therefore, even if a file recalled from the file system FS-C1 of the core-01 is stored in the FS-E1 of the edge-01, the file is immediately overwritten to another file system, which deteriorates the cache function of the storage apparatus 100.

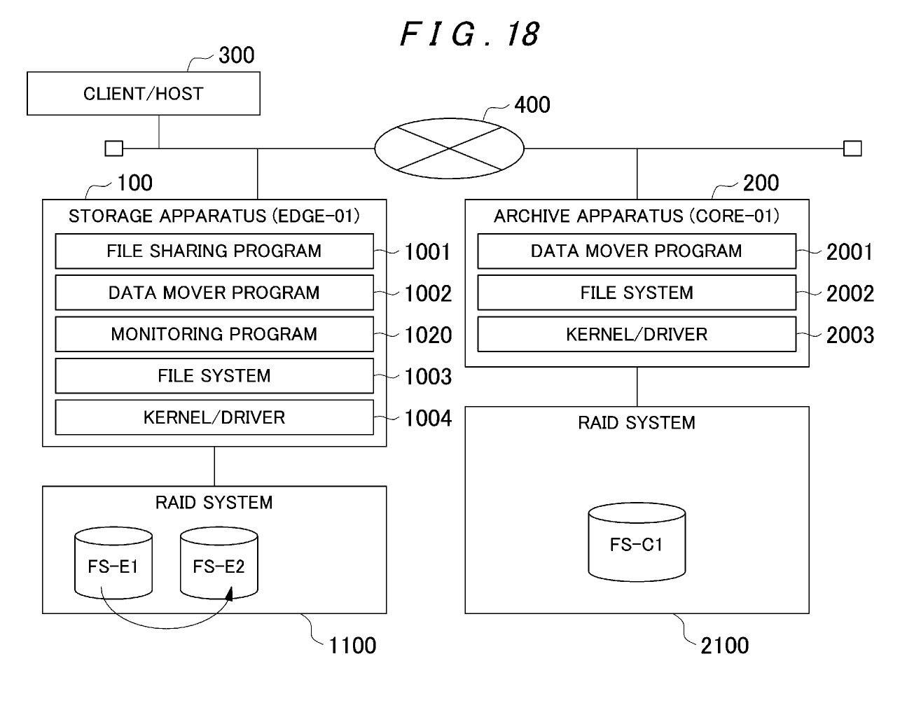

Next, the file system addition processing at STEP 200 is explained. As shown in FIG. 18, in the file system addition processing (STEP 200), if the ratio of the size of the storage area of the file system FS-E1 in the edge-01 to the size of the used area of the file system FS-C1 in the core-01 exceeds the threshold in the monitoring processing at step 100, the monitoring program 1020 determines that the cache effect of the edge-01 is deteriorated and notifies the data mover program 1002 that a file system must be added.

If notified by the monitoring program 1020 that a file system must be added, the data mover program 1002 adds a file system FS-E2 to the RAID system 1100 in the edge-01, and migrates the stub information which is added to the FS-E1 to the FS-E2. Subsequently, the data mover program 1002 updates the file management table 1015. It should be noted that, even if the file management table 1015 is updated, since it is concealed that the stub information was migrated to a different file system as explained above, the directory configuration as seen from the user is not changed.

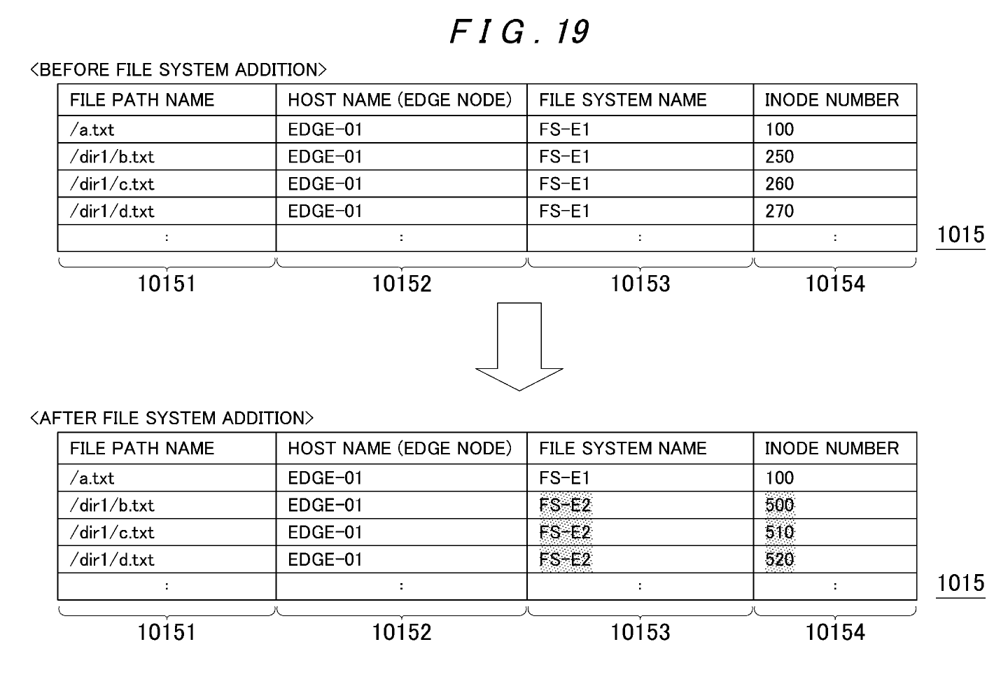

Here, how the file management table 1015 is updated if a file system is added to the edge-01 is explained. As shown in FIG. 19, if a file system is added to the edge-01, the file system names 10153 corresponding to “dir1/b.txt”, “dir1/c.txt”, and “dir1/d.txt” of the file path name [field] 10151 are respectively changed from “FS-El” to “FS-E2”. Furthermore, the inode numbers 10154 are respectively changed to the corresponding inode numbers “500”, “510”, and “520”.

As explained above, since the file path name presented to the user and the storage location of the file system are made to correspond to each other by utilizing the file management table 1015, the migration of the file system can be concealed from the user.

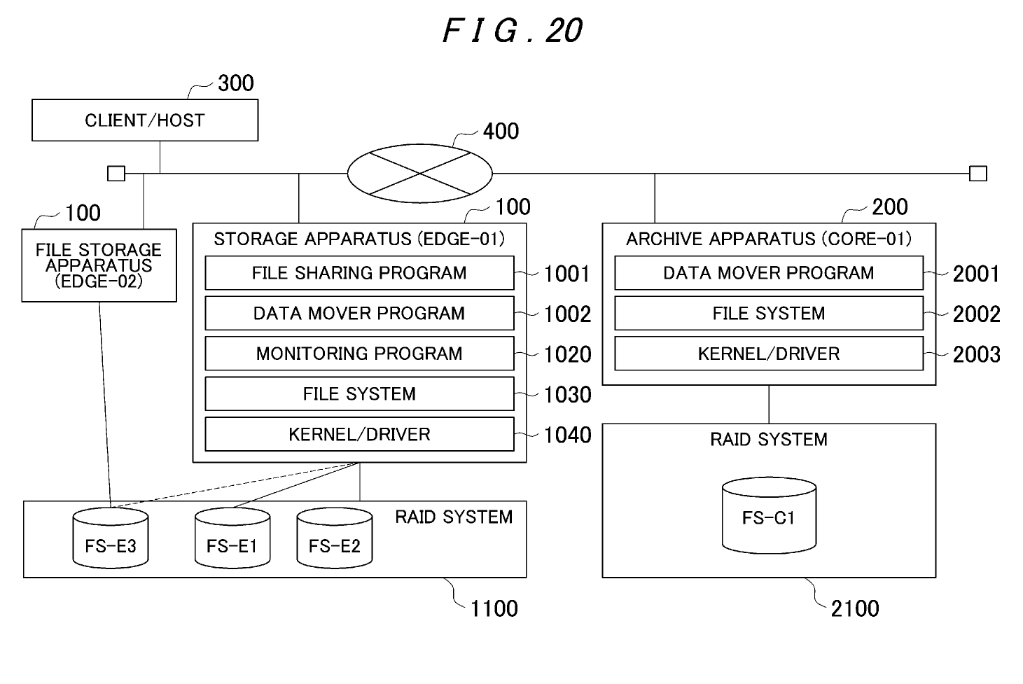

Next, the Edge node addition processing at STEP 300 is explained. As shown in FIG. 20, the Edge node addition processing (STEP 300) monitors the number of times of performing the file system addition processing at STEP 200 and, if the relevant number of times is repeated for a predetermined number of times or more and the recall frequency also exceeds a predetermined threshold, adds a new Edge node (edge-02).

Specifically, the monitoring program 1020 monitors the number of times of the file system addition processing at STEP 200 and monitors whether the relevant number of times is repeated for the predetermined number of times or more or not. Furthermore, the monitoring program 1020 monitors whether the recall frequency exceeds the predetermined threshold or not. If the number of times of the file system addition processing is repeated for the predetermined number of times or more and, at the same time, if the recall frequency exceeds the predetermined threshold, for preventing a bottleneck of the CPU in the edge-01, the monitoring program 1020 notifies the data mover program 1002 that a new Edge node (edge-02) must be added.

If notified by the monitoring program 1020 that a new Edge node must be added, the data mover program 1002 adds an edge-02, and adds a file system FS-E3 in the edge-01 to the edge-02. Subsequently, the data mover program 1002 updates the file management table 1015. It should be noted that, even if the new Edge node is added, since it is concealed that the stub information was migrated to a different file system as explained above, the directory configuration as seen from the user is not changed.

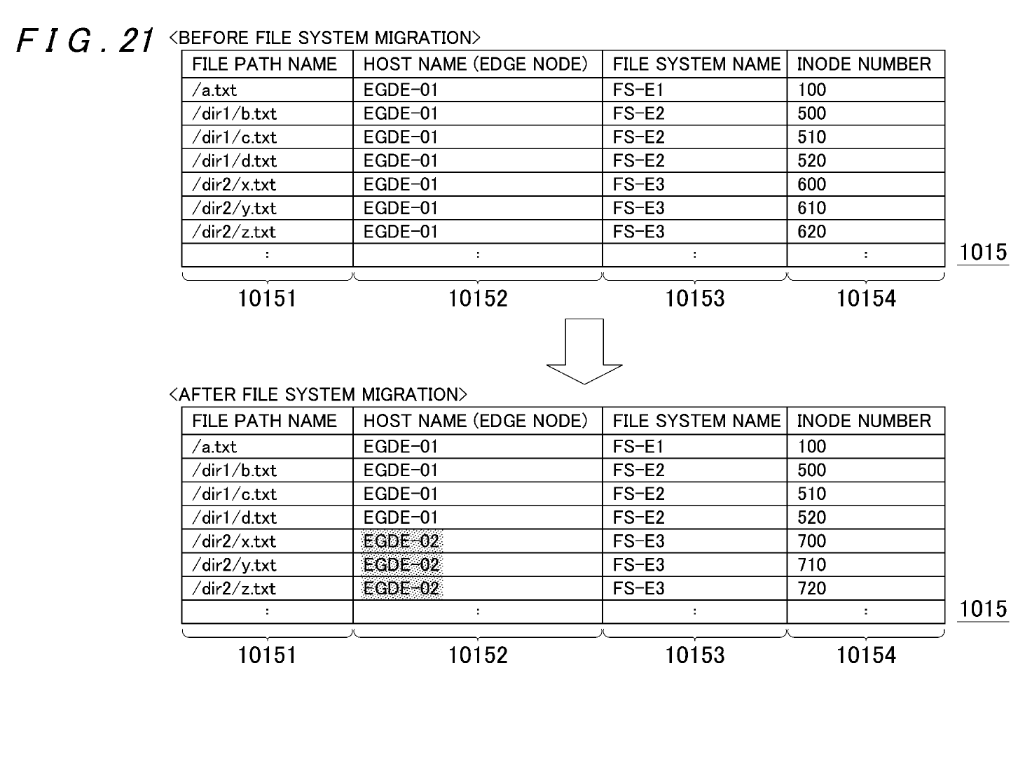

Here, how the file management table 1015 is updated if the edge-02 is added is explained. As shown in FIG. 21, if a new Edge node (edge-02) is added, the host names (edge nodes) 10152 corresponding to “dir2/x.txt”, “dir2/y.txt”, and “dir2/z.txt” of the file path name [field] 10151 are respectively changed from “edge-01” to “edge-02”.

As explained above, since the file path name presented to the user and the storage location of the file system are made to correspond to each other by utilizing the file management table 1015, the addition of the new node and the migration of the file system can be concealed from the user.

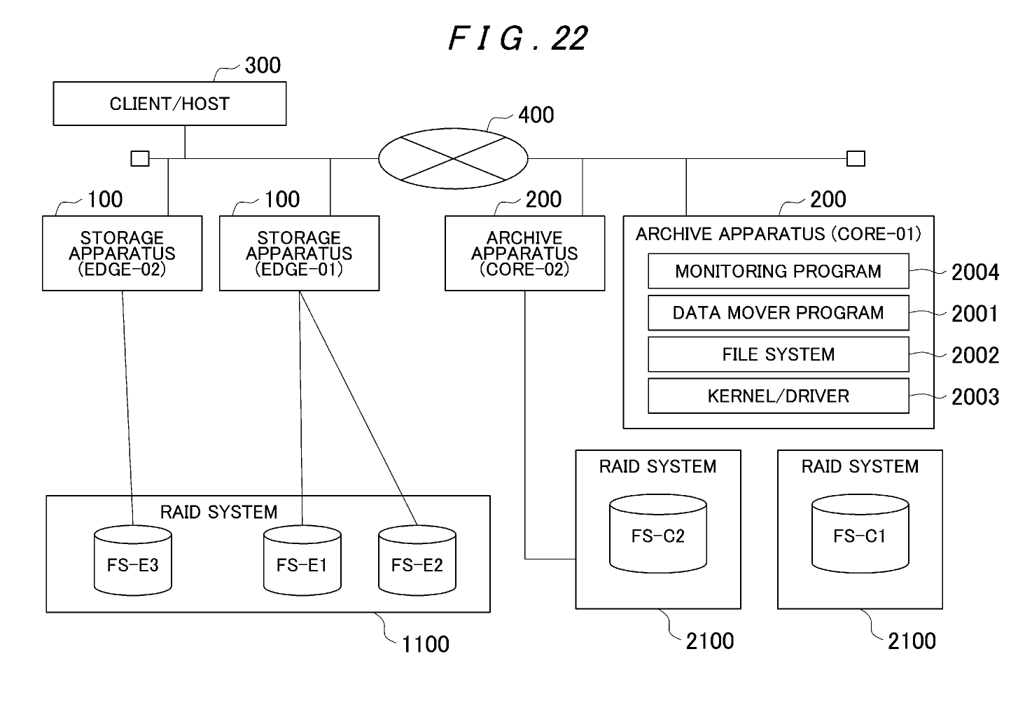

Next, the Core node addition processing at STEP 400 is explained. As shown in FIG. 22, the Core node addition processing (STEP 400) monitors the frequency of the recall intending a file update, if the relevant recall frequency exceeds a predetermined threshold, adds a new Core node (core-02). Here, the recall intending a file update indicates the recall after which resynchronization is requested such as the case where the data included in the file is rewritten and others. If [the frequency of] the recall intending a file update (hereinafter also explained as the update recall) increases, since the transfer for resynchronization after the recall increases and the load on the Core node becomes higher, a new Core node must be added.

Specifically, the monitoring program 2004 of the archive apparatus 200 monitors the frequency of the update recall, and determines whether the frequency of the update recall exceeds the predetermined threshold or not. If it is determined by the monitoring program 2004 that the frequency of the update recall exceeds the predetermined threshold, the data mover program 2001 adds a new Core node (core-02), and notifies the edge-02 of the address of the core-02. The data mover program 2001 notifies the edge-02 of the address of the core-02 along with the file data to be stored in the file.

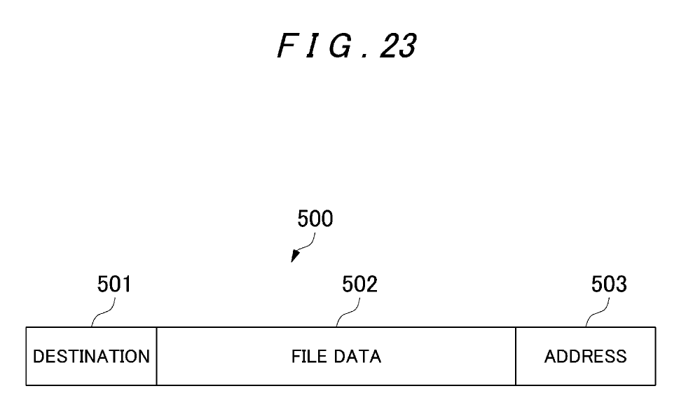

The data mover program 2001 transmits a data packet including the address of the core-02 to the edge-02. As shown in FIG. 23, the data packet includes a destination 501 in the header to be the destination of the data transmission and includes file data 502 and an address 503 in the payload. For example, the address of the edge-02 to be the storage destination of the recalled file is stored in the destination 501. Subsequently, the address of the core-02 to be the replication destination is stored in the address 503.

Subsequently, upon receiving the notification of the address of the core-02, the edge-02 changes the replication destination to the core-02. Furthermore, the file recalled by the core-01 is stored in the FS-E3 of the edge-02.

Subsequently, the recalled file stored in the FS-E3 of the edge-02 is replicated to the FS-C2 of the core-02. The core-02 stores the replicated file in the FS-C2. Subsequently, the core-02 requires the core-01 to delete the file corresponding to the file which was replicated to the FS-C2 among the files stored in the FS-C1 of the core-01. By this method, the older replication file stored in the FS-C1 of the core-01 is deleted.

Next, if the update processing occurs in the file recalled to the edge-02 at the foregoing STEP 400, the synchronization processing is performed. Here, the synchronization destination of the file which is recalled from the core-01 and is temporarily stored in the edge-02 is the core-02 which is notified from the core-01. Furthermore, as for the file data which is only referred to without being updated, after being recalled and temporarily stored in the edge-02, the entity of the file is deleted, and [the file] is stubbed. Therefore, there is a problem in that the file data which is only referred to by the recall processing and is not updated, for which the synchronization processing is not performed, is not migrated to the newly added Core node (core-02).

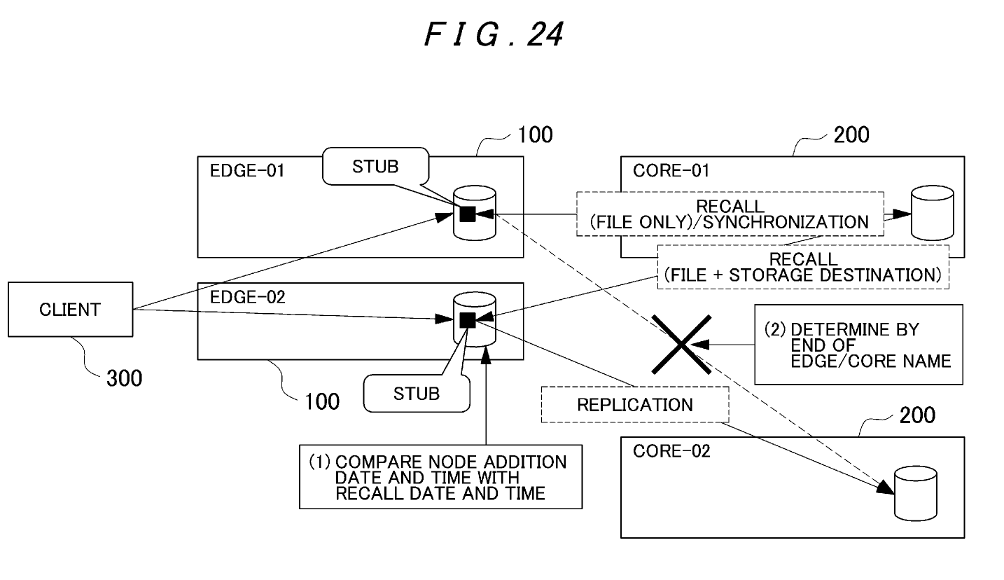

Therefore, in this embodiment, as shown in (1) of FIG. 24, if a new Core node is added, the date and time when the Core node was added and the date and time when the recall processing occurred are retained, and the date and time when the Core node was added and the date and time when the recall processing occurred are compared. Subsequently, if the recall processing occurs for the first time after the Core node is added, the information of the recalled file data is added to the list (replication list) of the file data for which the synchronization processing of the Edge node is requested. By this method, both the file data for which the update processing is performed and the file data which is only referred to without being updated are supposed to be replicated to the new Core node.

Furthermore, as the replication destination is changed from the core-01 to the core-02 at foregoing STEP 400, the replication destination (Core node) must be notified to the edge node on a timely basis. Therefore, for example, if the recall processing occurs and the new replication destination is notified at the time when the file data is returned from the Core node to the Edge node, it becomes unnecessary to prepare the communication means only for notifying the change of the replication destination. However, if the changed replication destination is notified each time the recall processing is performed, all the file data stored in the core-01 is migrated to the core-02.

Therefore, in this embodiment, as shown in (2) of FIG. 24, in the recall processing, in accordance with the combination of the Edges node and the Core nodes, whether to include the information of the replication destination in the response data in the recall processing or not is determined. For example, if the character strings at the end of the node names (e.g. “−01”, “−02”, and others) are equal, the information of the replication destination is controlled not to be included in the response data. Meanwhile, if the character strings at the end of the node names are different, the information of the replication destination is controlled to be included in the response data.

Next, the method for detecting whether the update recall processing increased or not is explained. It is explained above that the number of times of the recall intending the update (the update recall) is monitored and a Core node is added if the number of times of update recall exceeds the predetermined number of times. However, in this case, since a Core node is added after the number of times of the update recall exceeds the specified value, there is a problem in that it takes time since the Core node is added until the processing load is distributed.

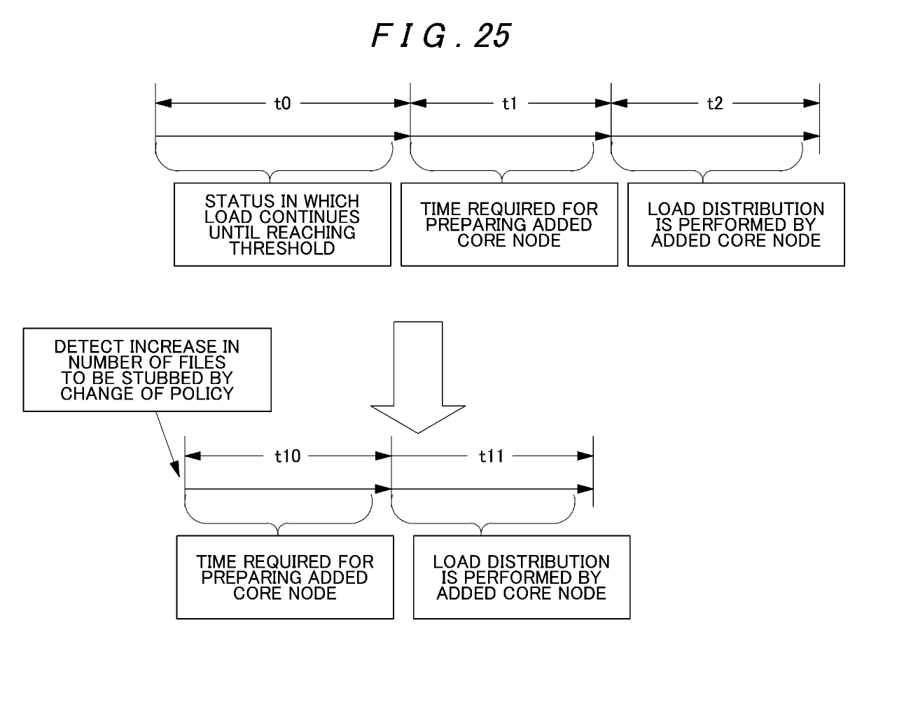

For example, as shown in FIG. 25, if a Core node is added by monitoring the number of times of the recall intending the update, the status in which the load remains on the “Core-01” is considered to continue until the Core node is actually added. Specifically, the status in which the load remains on the “Core-01” continues for the period of “t0”, that is, until the number of times of the update recall exceeds the predetermined number of times. Subsequently, after the number of times of the update recall exceeds the predetermined number of times, the Core node is added. Therefore, the period of “t1” becomes the time for preparing the added Core node. Subsequently, if the Core node is added in the period of “t1”, the stub is migrated to the Core node added in the period of “t2”, and therefore the load distribution of the Core nodes is performed.

Therefore, in this embodiment, as a method for shortening the time which is required until the Core node is added and the effect of processing load distribution and others is exerted, the method in which a Core node is added before the policy for stubbing is changed and the actual update recall increases can be considered. For example, as shown in FIG. 25, by changing the policy, the increase of the number of files to be stubbed is detected and the addition of a Core node is performed. By this method, without sustaining the status in which the load is on [the node] until [the number of times of the update recall] reaches the threshold, [the foregoing status] can be limited only to the “t10” which is the time required for preparing the added Core node and the “t11” which is the time when the load distribution is performed by the added Core node, and the effect of load distribution can be exerted in a short time by adding the Core node.

Specifically, the increase of the number of files to be stubbed by the change of the policy is detected by “Core-01”, and the added Core node is prepared in the period of “t10”. The change of the policy is, for example, as explained above, the timing for migrating file data and others, specifically speaking, the change of the last access (update) date which is the criteria for migrating the file data and stubbing the file and others.

If the last access date which is the criteria for stubbing the file is changed, the file of the newer last access date may also be the candidate to be stubbed, which causes the update recall to increase. Therefore, if the last access date which is the criteria for stubbing the file is changed, the update recall is predicted to increase in the future. Therefore, as explained above, by predicting the increase of the number of files in advance by the change of the policy and adding the Core node, it is made possible to prevent the status in which the load is on [the node] until the number of times of update recall exceeds the predetermined number of times and exert the effect of load distribution in a short time.

Furthermore, though the change of the policy is detected and the Core node is added in FIG. 25, for example, it is also possible to detect the CPU operation rate of the Core node and add a Core node in accordance with the CPU operation rate. Furthermore, it is also possible to detect the number of Edge nodes which access a Core node and add the Core node in accordance with the number of accesses of the Edge nodes.

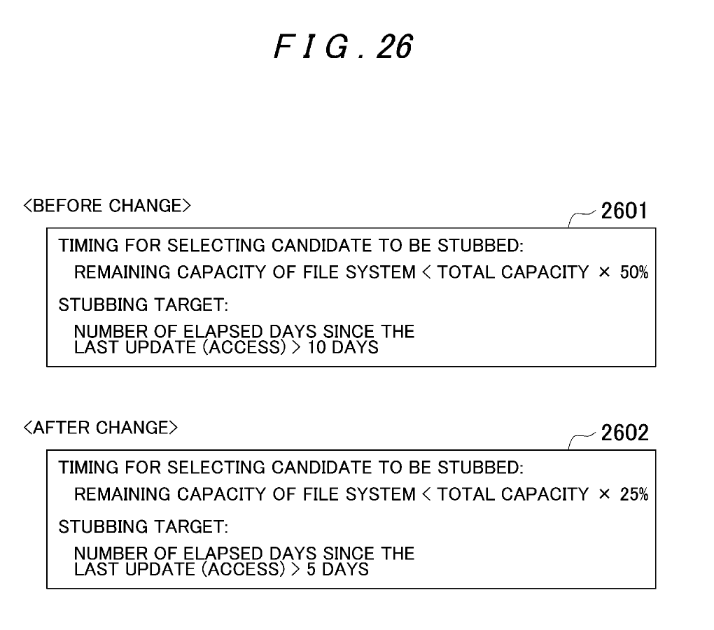

Here, an example of changing the policy is explained. The policy is stored in the memory 201 of the archive apparatus 200 (Core node). The relevant policy is changed in accordance with the input by the system administrator. For example, as shown in FIG. 26, the timing for selecting the candidate to be stubbed and the stubbing target are stored in the policy. For example, in the policy 2601 before the change, the timing for selecting the candidate to be stubbed is set as “remaining capacity of file system <total capacity*50%”, and the stubbing target is set as “number of elapsed days since the last update (access)>10 days”. Subsequently, in the policy 2602 after the change, the timing for selecting the candidate to be stubbed is set as “remaining capacity of file system<total capacity*25%”, and the stubbing target is set as “number of elapsed days since the last update (access)>5 days”.

As explained above, if the timing for selecting the candidate to be stubbed is changed from “remaining capacity of file system<total capacity*50%” to “25%” or if the stubbing target is changed from “number of elapsed days since the last update (access)>10 days” to “5 days”, the timing for stubbing may be earlier after the change or the number of files as the stubbing target may increase. Therefore, the possibility that the update recall occurs frequently may be higher. Therefore, in this embodiment, the Core node detects the change of the policy, and determines whether the relevant change is the change which causes the update recall to occur frequently or not. Subsequently, if determining that the relevant change is the change which causes the update recall to occur frequently, a Core node is added and the load on the Core nodes is distributed.

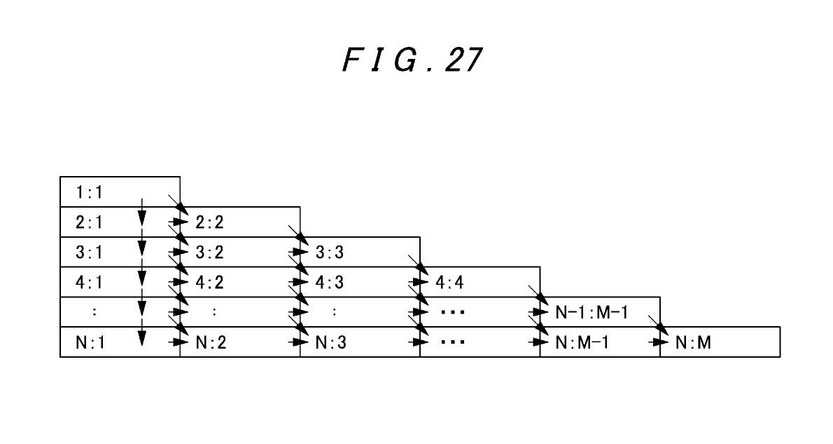

Next, the number of Edge nodes and the process of adding Core nodes in cases where the foregoing monitoring processing (STEP 100), file system addition processing (STEP 200), Edge node addition processing (STEP 300), and Core node addition processing (STEP 400) are repeated are explained. As shown in FIG. 27, if the monitoring processing (STEP 100), the file system addition processing (STEP 200), the Edge node addition processing (STEP 300), and the Core node addition processing (STEP 400) are repeated in the computer system 1, [the status in which] the number of Edge nodes is “1” and the number of Core nodes is “1” is changed to [the status in which] one is added to the number of Edge nodes or [to the the status in which] both the number of Edge nodes and the number of Core nodes are increased.

Edge nodes are firstly added in accordance with the capacity of the file data, the line speed and others and the number of Edge nodes becomes “N” while the number of Core nodes is “1” or, in other cases, Edge nodes and Core nodes are sequentially added. Subsequently, eventually, in accordance with the capacity of the file data and others, the appropriate number of units of Edge nodes and Core nodes (“N” Edge nodes: “M” Core nodes) are supposed to be added. Here, the Core nodes added are configured including the storage apparatus 100, and the Edge nodes are configured including the storage apparatus 200.

### (1-5) Details of Operation of Computer System

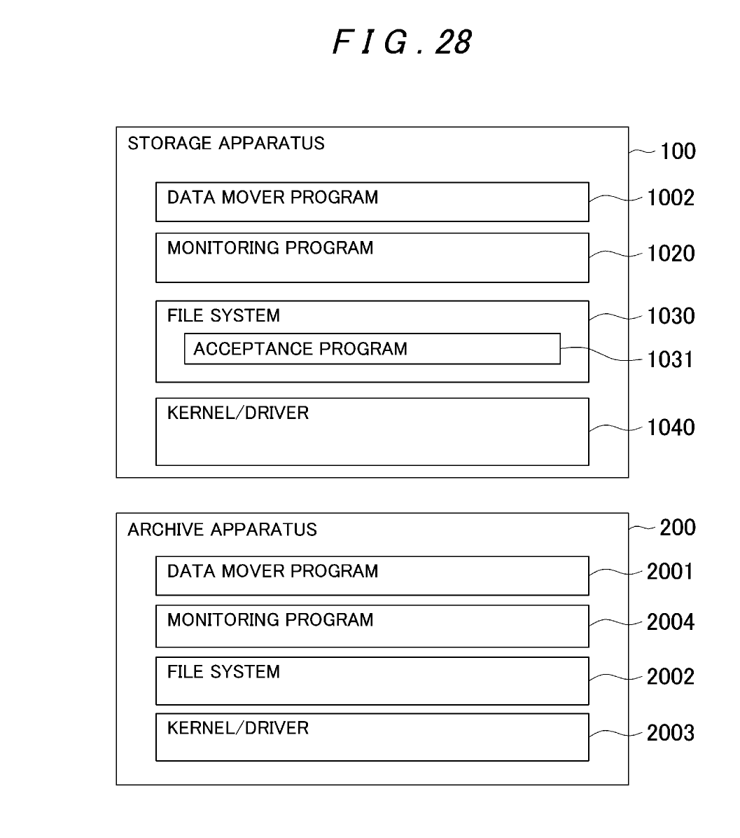

Next, the details of the processing in the computer system 1 are explained. Hereinafter, specifically, the data migration processing by the data mover program 1002 of the storage apparatus 100 (Edge node), the data migration processing by the data mover program 2001 of the archive apparatus 200 (Core node), the read/write acceptance processing by the file system 1030 of the storage apparatus 100, the monitoring processing by the monitoring program 1020 of the storage apparatus 100, and the monitoring processing by the monitoring program 2004 of the archive apparatus 200 are explained. As shown in FIG. 28, in the file system 1030 of the storage apparatus 100, furthermore, an acceptance program 1031 is included.

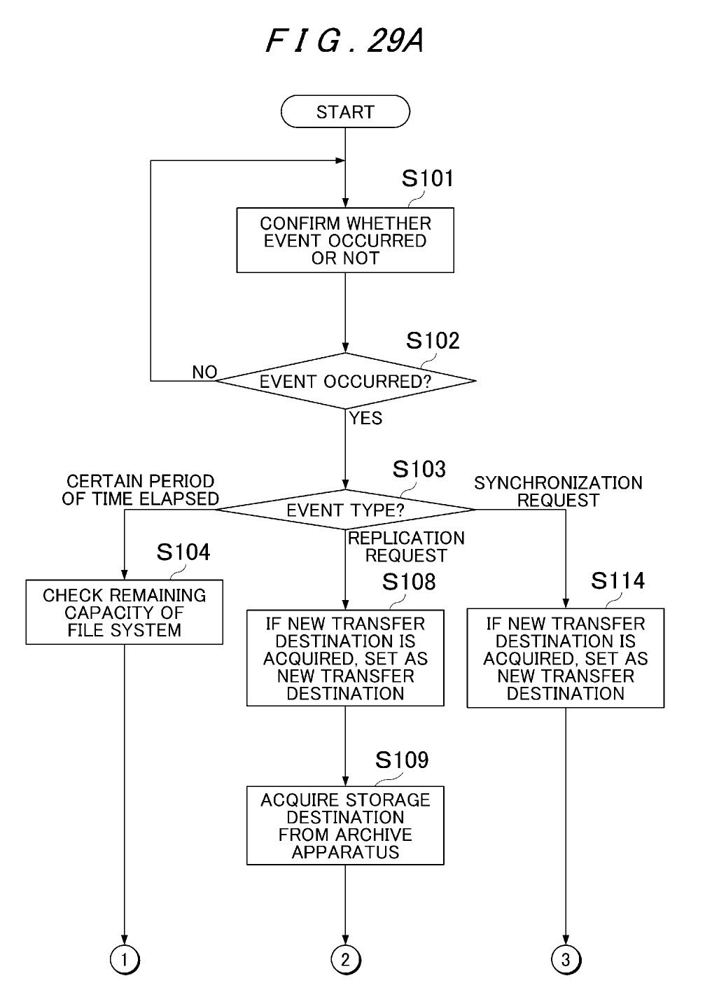

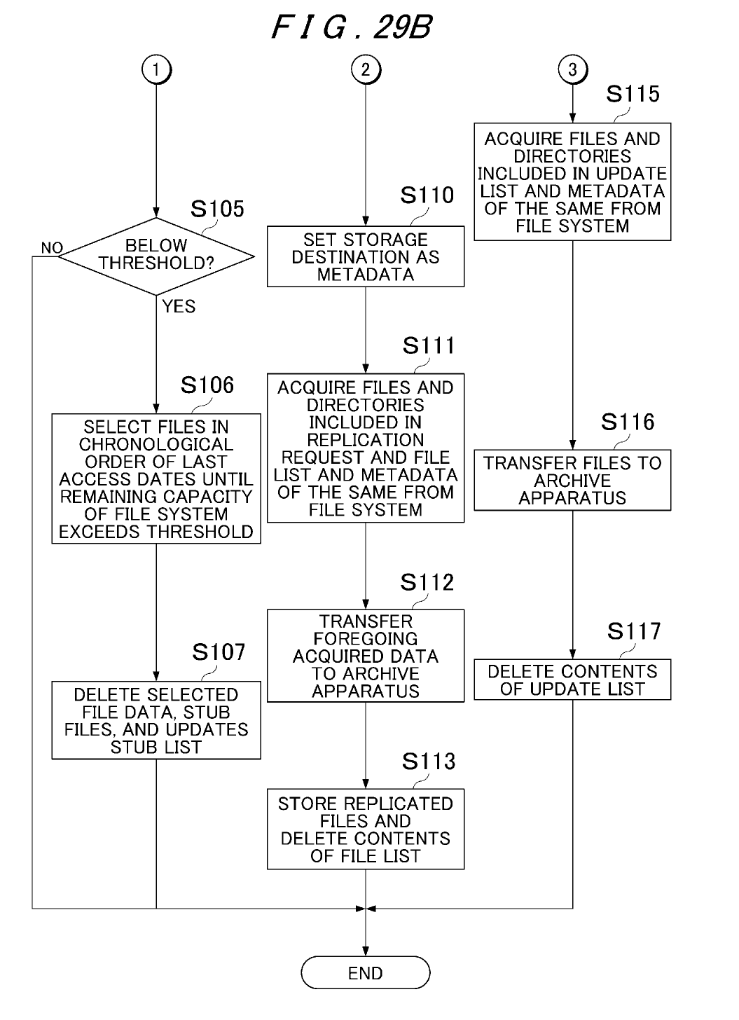

Firstly, the details of the data migration processing by the data mover program 1002 of the storage apparatus 100 are explained. As shown in FIG. 29A and 29B, firstly, the data mover program 1002 confirms whether an event occurred or not (S101), and determines whether an event occurred or not (S102). If it is determined at step S102 that an event occurred, the data mover program 1002 confirms what the event type is (S103). Meanwhile, if it is not determined at step S102 that an event occurred, the data mover program 1002 repeats the processing of step S101.

As the event which the data mover program 1002 confirms at step S101, for example, the events such as whether a certain period of time elapsed or not, whether the replication processing is requested or not, and whether the synchronization processing is requested or not can be illustrated.

That a certain period of time elapsed indicates that the status in which no event such as the replication processing or the synchronization processing occurred continues for a certain period of time. The replication processing is the processing performed in accordance with the input by the administrator and, as explained above, is the processing of storing the data stored in the storage apparatus 100 in another storage apparatus. Furthermore, the synchronization processing is the processing of synchronizing the files between the replication source and the replication destination after the replication processing is performed.

Subsequently, if it is determined at step S103 that the event type is “a certain period of time elapsed”, the data mover program 1002 checks the remaining capacity of the file system in the storage apparatus 100 (S104).

Subsequently, if it is determined at step S104 that the remaining capacity of the file system is below a predetermined threshold, the data mover program 1002 selects files in the chronological order of last access dates until the remaining capacity of the file system is over the threshold (S106). Specifically, the data mover program 1002 adds the capacity of the selected files to the remaining capacity of the file system, and determines whether the [total] value after the addition is over the predetermined threshold or not.

Subsequently, the data mover program 1002 deletes the file data of the files selected at step S106, stubs the relevant files, and updates the stub list 1013 (S107). Specifically, the data mover program 1002 updates the stubbed file names, the file sizes, the dates and time of stubbing (dates and time of latest stubbing), and the number of times of stubbing in the stub list 1013.

Meanwhile, if it is determined at step S104 that the remaining capacity of the file system is not below the predetermined threshold, [the data mover program 1002] terminates the processing.

Furthermore, if it is determined at step S103 that the event type is a “replication request”, the data mover program 1002, if already acquiring the new transfer destination, sets the relevant transfer destination as the new transfer destination of the files (S108). At step S108, the new transfer destination indicates the archive apparatus 200 (Core node) added at the foregoing STEP 400. The address of the new transfer destination is notified by the archive apparatus 200 if the frequency of the recall processing with the view to the file update exceeds a predetermined threshold. Therefore, the data mover program 1002, if the address of the new transfer destination is notified by the archive apparatus 200, sets the relevant address as the transfer destination of the file data.

Subsequently, the data mover program 1002 acquires the storage destination of the file data from the archive apparatus 200 at the transfer destination which is set at step S108 (S109). Subsequently, the data mover program 1002 sets the storage destination of the file data acquired at step S109 as the metadata including, the information of the transfer source files and the transfer destination and others (S110).

Subsequently, the data mover program 1002 acquires the files and directories included in the replication request and the file list 1011 and the metadata of the files and directories from the file system (S111). Subsequently, the data mover program 1002 transfers the data acquired at step S111 to the archive apparatus 200 as the transfer destination set at step S108 (S112). Subsequently, the data mover program 1002 stores the files transferred at step S112 as the replicated files, and deletes the contents of the file list 1011 (S113).

Furthermore, if it is determined at step S103 that the event type is a “synchronization request”, the data mover program 1002, if already acquiring the new transfer destination, sets the relevant transfer destination as the new transfer destination of the files (S114). At step S114, as the foregoing step S108, the new transfer destination is the archive apparatus 200 (Core node) added at the foregoing STEP 400. The address of the new transfer destination is notified by the archive apparatus 200 if the frequency of the recall processing with the view to the file update exceeds a predetermined threshold. Therefore, the data mover program 1002, if the address of the new transfer destination is notified by the archive apparatus 200, sets the relevant address as the transfer destination of the file data.

Subsequently, the data mover program 1002 acquires the files and directories stored in the update list 1012 and the metadata of the files and directories from the file system (S115). Subsequently, the data mover program 1002 transfers the files acquired at step S115 to the archive apparatus 200 as the transfer destination set at step S114 (S116). Subsequently, the data mover program 1002 deletes the contents of the update list 1012 (S117).

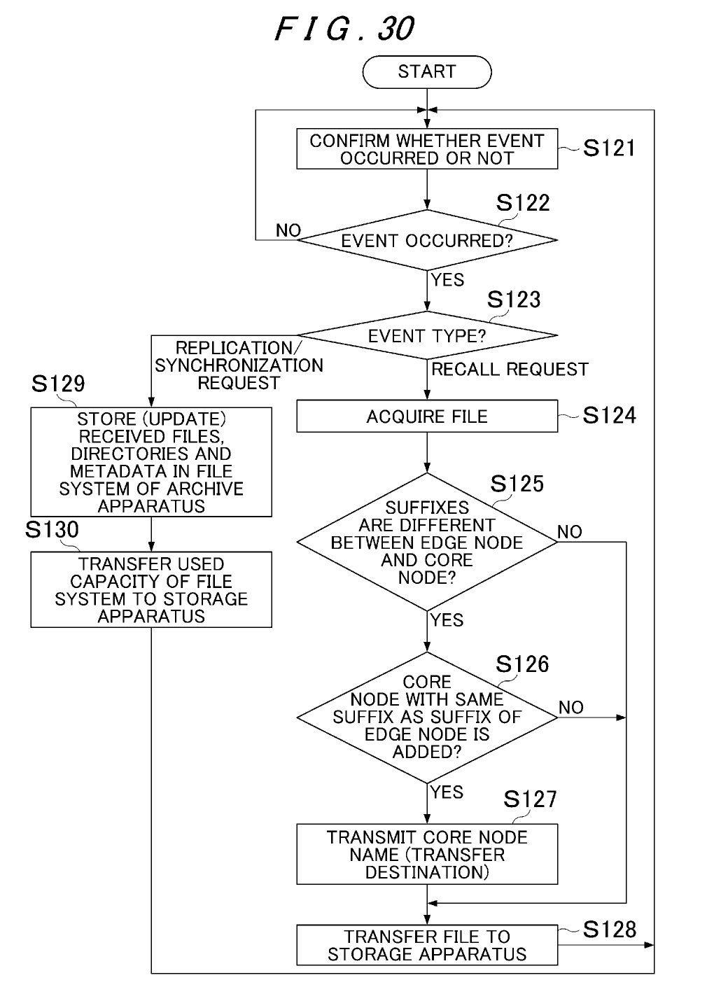

Next, the details of the data migration processing by the data mover program 2001 of the archive apparatus 200 are explained. As shown in FIG. 30, firstly, the data mover program 2001 confirms whether an event occurred or not (S121). If confirming at step S121 that an event occurred (S122), the data mover program 2001 confirms what the event type is (S123). Meanwhile, if unable to confirm at step S122 that an event occurred, the data mover program 2001 repeats the processing of step S121.

As the event which the data mover program 2001 confirms at step S121, for example, the events such as whether the replication/synchronization processing is requested or not, and whether the recall processing is requested or not can be illustrated. As for the archive apparatus 200, the subsequent processing is the same whether the replication processing is requested or the synchronization processing is requested.

If it is determined at step S123 that the event type is a “replication/synchronization request”, the data mover program 2001 stores the received files and directories and the metadata of the files and directories in the file system of the archive apparatus 200 (S129). At step S129, if the event type is a synchronization request, the data mover program 2001 updates the file system of the archive apparatus 200 in accordance with the received files and others.

Subsequently, the data mover program 2001 transfers the used capacity of the file system of the archive apparatus 200 to the storage apparatus 200 (S130).

Furthermore, if it is determined at step S123 that the event type is a “recall request”, [the data mover program 2001] acquires the recall target file stored in the archive apparatus 200 (S124). Subsequently, the data mover program 2001 determines whether the character strings at the end of the node name (suffix) of the Edge node (storage apparatus 100) for which the recall request is made and the character strings at the end of the node name (suffix) of the Core node are equal or not (S125).

If it is determined at step S125 that the names at the end of the Edge node and the Core node are different, the data mover program 2001 determines whether the archive apparatus 200 (Core node) with the same suffix as the suffix of the storage apparatus 200 (Edge node) is added or not (S126). Meanwhile, if it is determined at step S125 that the names at the end of the Edge node and the Core node are equal, the data mover program 2001 performs the processing of step S128.

Subsequently, if it is determined at step S126 that the Core node with the same suffix as the suffix of the Edge node is added, [the data mover program 2001] transmits the name of the Core node as the transfer destination of the file data to the Edge node (S127). Meanwhile, if it is determined at step S126 that the Core node with the same suffix as the suffix of the Edge node is not added, the data mover program 2001 performs the processing of step S128.

As explained above, by comparing the character strings at the end of the node names, it is possible to determine whether to include the information of the replication destination in the response data at the recall processing or not. For example, if the character strings at the end of the node names (e.g. “−01”, “−02”, and others) are equal, the information of the replication destination is controlled not to be included in the response data while, if the character strings at the end of the node names are different, the information of the replication destination is controlled to be included in the response data, by which it can be ensured that all the files stored in the archive apparatus 200 may not be migrated to the newly added archive apparatus.

Subsequently, the data mover program 2001 transfers the recall target file to the storage apparatus 200 (S128).

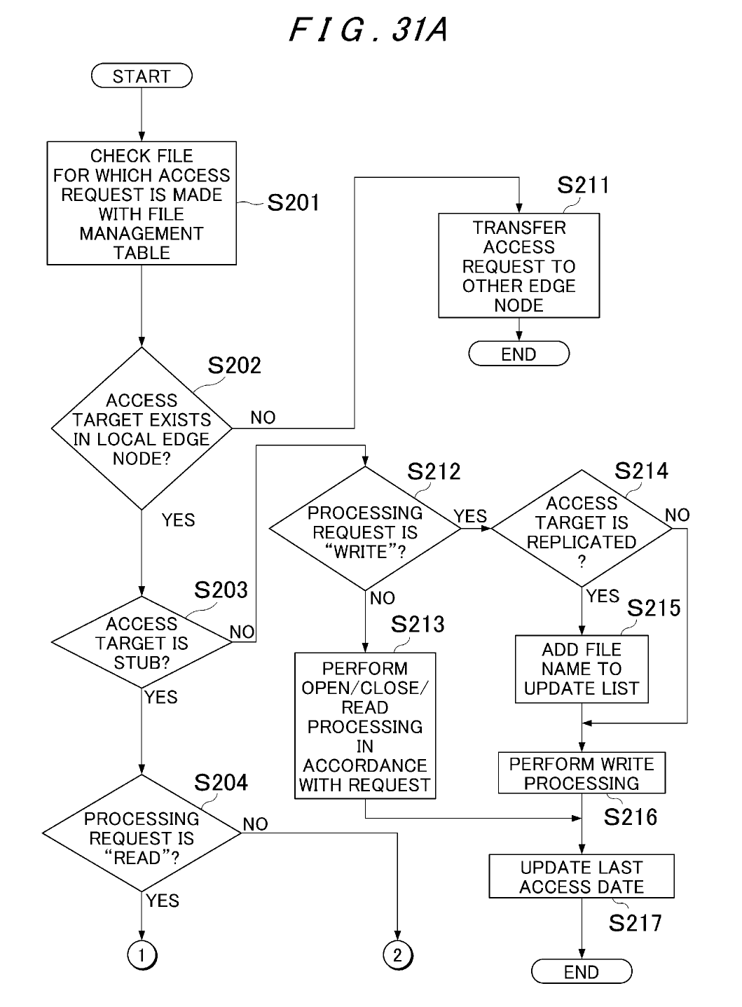

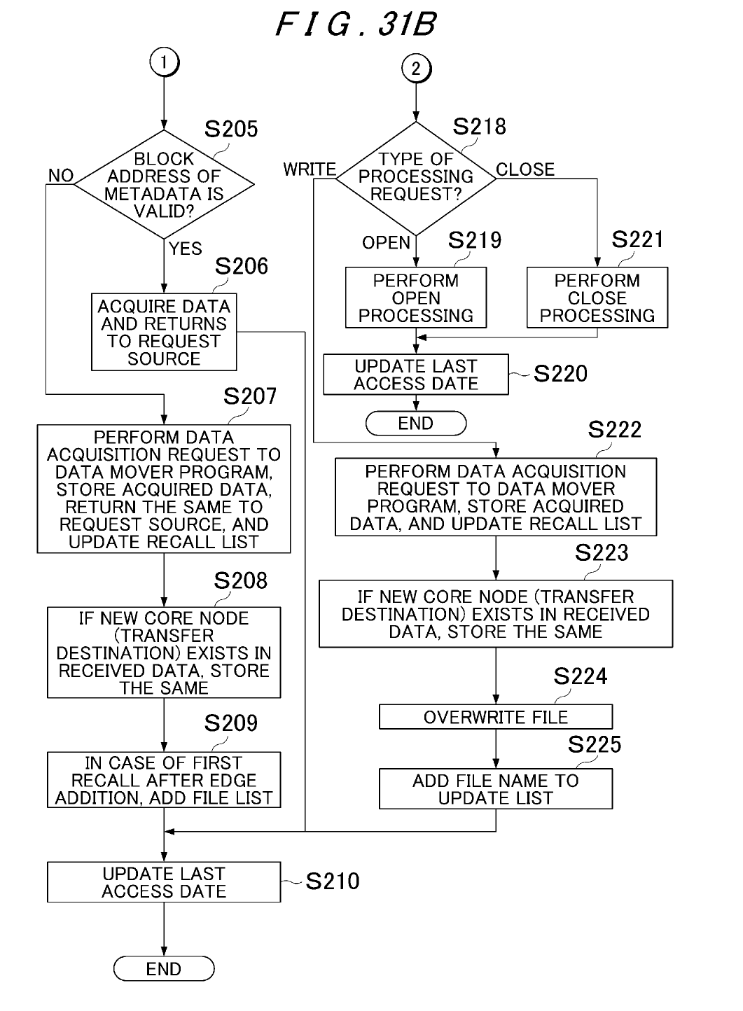

Next, the details of the read/write acceptance processing by the file system 1030 of the storage apparatus 100 are explained. Specifically, the acceptance program 1031 of the file system 1030 performs the read/write acceptance processing. As shown in FIG. 31A and 31B, firstly, the acceptance program 1031 checks the file for which the client/host 300 made an access request with the file management table 1015, and identifies the host name, the file system name, and others corresponding to the file for which the access request is made (S201).

The acceptance program 1031 determines whether the access target file exists in the local Edge node (the local storage apparatus 100) or not (S202). Specifically, whether [the location is] the local Edge node or not is determined in accordance with whether the host name identified at step S201 is the same as the locad Edge node or not. Subsequently, if it is determined at step S202 that the access target exists in the local Edge node, the acceptance program 1031 determines whether the access target is a stub or not (S203). Specifically, the acceptance program 1031 refers to the stub list 1013, and determines whether the access target file is stubbed or not.

Meanwhile, if it is determined at step S202 that the access target does not exist in the local Edge node, the acceptance program 1031 transfers the access request to the other Edge node where the file is stored (S211), and terminates the processing.

Subsequently, if it is determined at step S203 that the access target is a stub, the acceptance program 1031 performs the processing of step S204 and later. Meanwhile, if it is determined at step S203 that the access target is not a stub, the acceptance program 1031 performs the processing of step S212 and later.

At step S204, the acceptance program 1031 determines whether the processing request is “read” or not (S204). If it is determined at step S204 that the processing request is “read”, the acceptance program 1031 performs the processing of step S205 and later. Meanwhile, if it is determined at step S204 that the processing request is not “read”, the acceptance program 1031 performs the processing of step S218 and later.

At step S205, the acceptance program 1031 determines whether the block address of the metadata is valid or not (S205). Here, that the block address of the metadata is valid indicates that the data once read to the Edge node exists as a cache.

If it is determined at step S205 that the block address of the metadata is valid, the acceptance program 1031 acquires the data existing as the cache, and returns the same to the request source client/host 300 (S206). Meanwhile, if it is determined at step S205 that the block address of the metadata is not valid, [the acceptance program 1031] performs the processing of step S207.

At step S207, the acceptance program 1031 performs a data acquisition request to the data mover program 1002 of the storage apparatus 100, stores the acquired data in the storage apparatus 100, and returns the same to the client/host 300 (S207). At step S207, the acceptance program 1031 further updates the file name, the file size, the last recall date and time, the number of times of recall, the average recall interval, the number of access users at recall, and others in the recall list 1014.

Subsequently, if a new Core node is included in the received data transmitted by the data mover program 1002 from the archive apparatus 200, the acceptance program 1031 stores the relevant Core node as the transfer destination of the file data (S208). Subsequently, if this is the first recall after the addition of the Edge node, the acceptance program 1031 adds the information of the file to be the recall target in the file list 1011 (S209). Subsequently, the acceptance program 1031 updates the last access date included in the metadata of the file and terminates the processing (S210).

Meanwhile, if it is determined at step S203 that the access target is not a stub, the acceptance program 1031 determines whether the processing request is “write” or not (S212). If it is determined at step S212 that the processing request is not “write”, the acceptance program 1031 performs any one type of processing “open/close/read” for the target file in accordance with the processing request (S213). Subsequently, the acceptance program 1031 performs the processing of step S217 which is explained later.

Meanwhile, if it is determined at step S212 that the processing request is “write”, the acceptance program 1031 determines whether the access target is a replicated file or not (S214). If it is determined at step S214 that the access target is a replicated file, the acceptance program 1031 adds the file name of the file to be the target to the update list 1012 (S215). Subsequently, the acceptance program 1031 performs the “write” processing for the target file in accordance with the processing request (S216). Subsequently, the acceptance program 1031 updates the last access date included in the metadata of the file (S217).

Furthermore, if it is determined at step S204 that the processing request is not “read”, the acceptance program 1031 determines the type of processing request (S218). If it is determined at step S218 that the processing request is “write”, the acceptance program 1031 performs a data acquisition request to the data mover program 1002, stores the acquired data in the storage apparatus 100, and returns the same to the client/host 300 (S222). At step S222, the acceptance program 1031 further updates the file name, the file size, the last recall date and time, the number of times of recall, the average recall interval, the number of access users at recall, and others in the recall list 1014.

Subsequently, if a new Core node is included in the received data transmitted by the data mover program 1002 from the archive apparatus 200, the acceptance program 1031 stores the relevant Core node as the transfer destination of the file data (S223). Subsequently, the acceptance program 1031 overwrites the target file (S224). Subsequently, [the acceptance program 1031] adds the file name of the file which became the write target to the update list 1012 (S225). Finally, the acceptance program 1031 updates the last access date included in the metadata of the file, and terminates the processing (S210).

Meanwhile, if it is determined at step S218 that the processing request is “open”, the acceptance program 1031 performs the open processing for the target file (S219). Furthermore, if it is determined at step S218 that the processing request is “close”, the acceptance program 1031 performs the close processing for the target file (S221). Subsequently, the acceptance program 1031 updates the last access date included in the metadata of the file and terminates the processing (S220).

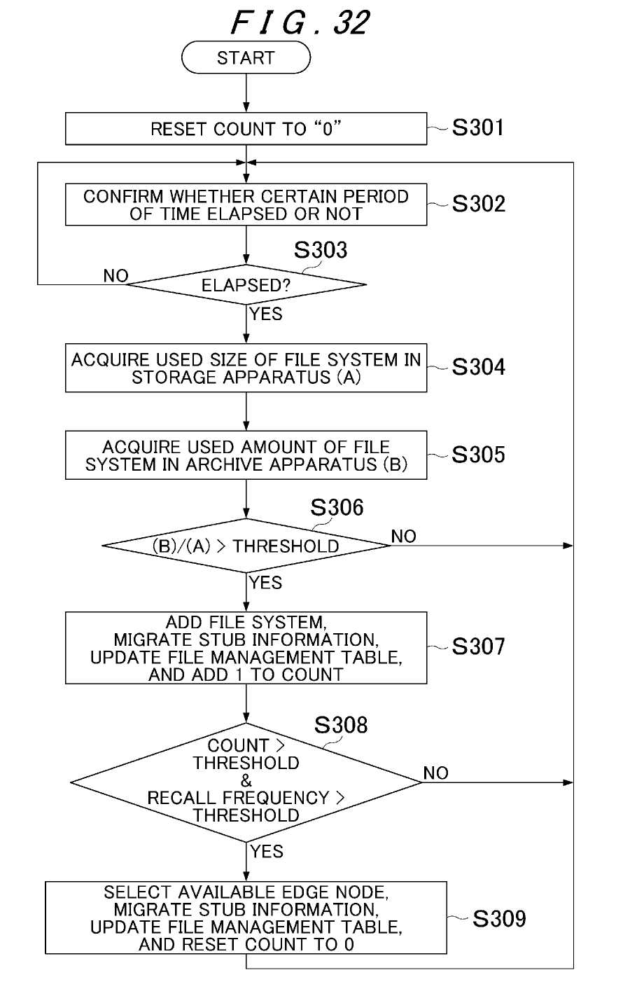

Next, the monitoring processing by the monitoring program 1020 of the storage apparatus 100 is explained. As shown in FIG. 32, firstly, the monitoring program 1020 resets the count to “0” (S301). Subsequently, the monitoring program 1020 confirms whether a certain period of time elapsed or not (S302), and determines whether the certain period of time elapsed or not (S303)

If it is determined at step S303 that the certain period of time elapsed, the monitoring program 1020 acquires the used size of the file system in the storage apparatus 100 (S304). Here, the used size of the file system acquired at step S304 is referred to as (A). The used size of the file system indicates the size of the entire file system. Subsequently, the monitoring program 1020 acquires the used amount of the file system in the archive apparatus 200 (S305). Here, the used amount of the file system acquired at step S305 is referred to as (B). The used amount of the file system indicates the capacity of the area which is actually used in the size of the entire file system.

Meanwhile, if it is determined at step S303 that the certain period of time has not elapsed, the monitoring program 1020 repeats the processing of step S302.

Subsequently, the monitoring program 1020 compares the ratio of the used size (A) acquired at step S304 to the used amount (B) acquired at step S305 and the threshold set in advance (S306). At step S306, the monitoring program 1020 performs the comparison by using the formula below.

### [Math.1]

(B)/(A)>Threshold: (1)

As explained above, (A) is the used size of the file system of the storage apparatus 100, and (B) is the used amount of the file system of the archive apparatus 200. It can be said that [the ratio of] the capacity of the file system stored in the archive apparatus 200 to the capacity of the entire file system in the storage apparatus 100 is larger as the value of (B)/(A) is larger. In this case, the file which is recalled from the archive apparatus 200 and temporarily stored in the storage apparatus 100 is overwritten immediately, and the cache function of the storage apparatus 100 is deteriorated. Therefore, if (B)/(A) is larger than the predetermined threshold, a file system and a storage apparatus 100 are newly added by the processing of step S307 and later.

If it is determined at step S306 that (B)/(A) is larger than the threshold, the monitoring program 1020 performs the addition of a file system, the migration of the stub information, and the update of the file management table 1015 (S307). At step S307, the monitoring program 1020 further adds 1 to the count.

Meanwhile, if it is determined at step S306 that (B)/(A) is equal to or smaller than the threshold, the monitoring program 1020 repeats the processing of step S302 and later.

Subsequently, the monitoring program 1020 determines whether the count is larger than a predetermined threshold and, at the same time, the recall frequency is larger than a predetermined threshold or not (S308). If it is determined at step S308 that the count is larger than the predetermined threshold and, at the same time, the recall frequency is larger than the predetermined threshold, the monitoring program 1020 selects an available Edge node, and performs the migration of the stub information and the update of the file management table (S309). At step S309, the monitoring program 1020 resets the count to 0.

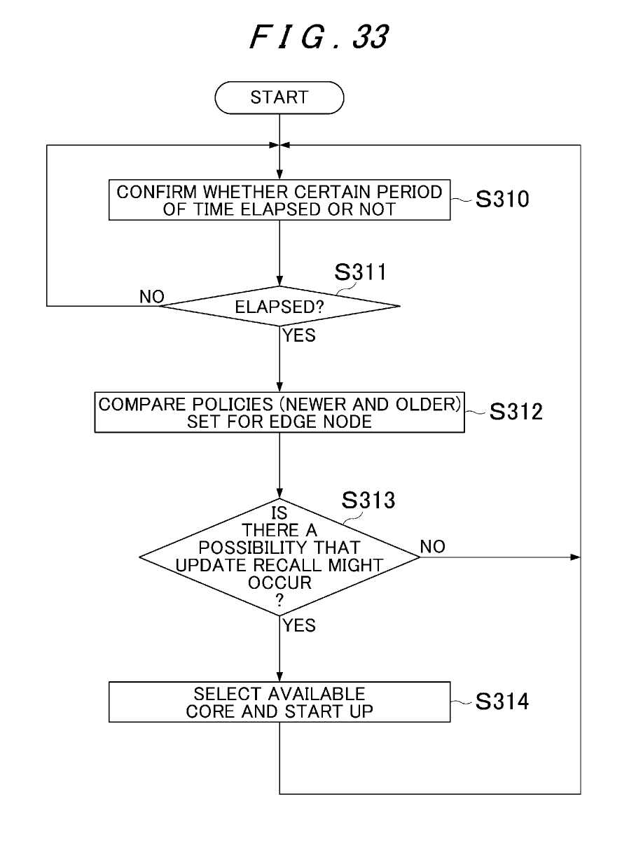

Next, the monitoring processing by the monitoring program 2004 of the archive apparatus 200 is explained. As shown in FIG. 33, firstly, the monitoring program 2004 confirms whether a certain period of time elapsed or not (S310), and determines whether the certain period of time elapsed or not (S311).

If it is determined at step S311 that the certain period of time elapsed, the monitoring program 2004 compares the new policy with the old policy which are set for the Edge node (S312). At step S312, by comparing the new policy with the old policy, it is possible to detect the increase of the number of files to be stubbed and determine whether the update recall increases or not. For example, if the remaining capacity of the file system is changed from the 50% to 25% of the total capacity or if the number of elapsed days since the last update (access) date of the stubbing target is changed from 10 days to 5 days, the timing for stubbing may be earlier or the number of files as the stubbing target may increase before or after the change.

Meanwhile, if it is determined at step S311 that the certain period of time has not elapsed, the monitoring program 2004 repeats the processing of step S310.

Subsequently, the monitoring program 2004 determines whether there is a possibility that the update recall may increase or not by the result of the comparison at step S312 of the new policy with the old policy (S313). If it is determined at step S313 that there is a possibility that the update recall may increase, a new available Core node is selected and is started up (S314). Subsequently, the monitoring program 2004 repeats the processing of step S310.

Meanwhile, if it is determined at step S313 that there is no possibility that the update recall increases, [the monitoring program 2004] repeats the processing of step S310.

### (1-6) Advantageous Effects of this Embodiment

As explained above, in the computer system 1 according to this embodiment, the entity of the data replicated to the archive apparatus 200 is deleted from the disk 115 of the storage apparatus 100, the relevant data is stubbed, the stubbed data is called from the archive apparatus 200 in accordance with the request from the client/host 300, and the entity of the data is temporarily stored in the disk 115. Subsequently, if the area where the entity of the stubbed data is stored in the storage area in the data storage area in the disk 115 is equal to or smaller than a predetermined capacity, the storage apparatus 100 migrates the stub information related to the stubbed data to a disk 115 in another storage apparatus 100. By this method, by the recall processing of calling the stubbed data from the archive apparatus 200, it becomes possible to prevent the deterioration of the cache function of the storage apparatus 100 and improve the access performance of the storage apparatus 100.

### (2) Second Embodiment

### (2-1) Configuration of Computer System

As the hardware configuration of the computer system 2 related to this embodiment is the same as the hardware configuration of the computer system 1 related to the Embodiment 1, the detailed explanation thereof is omitted. Furthermore, as the software configuration of the computer system 1 is also nearly the same as the Embodiment 1, the configuration which is different from the Embodiment 1 is explained specifically in detail.

In the First Embodiment, the migration of the file data stored in the archive apparatus 200 (Core node) is performed triggered by the recall request from the storage apparatus 100. Specifically, by notifying the address of the added Core node with the recalled file when the recalled file is transferred to the storage apparatus 100 from the archive apparatus 200, the file data is migrated to the new Core node.

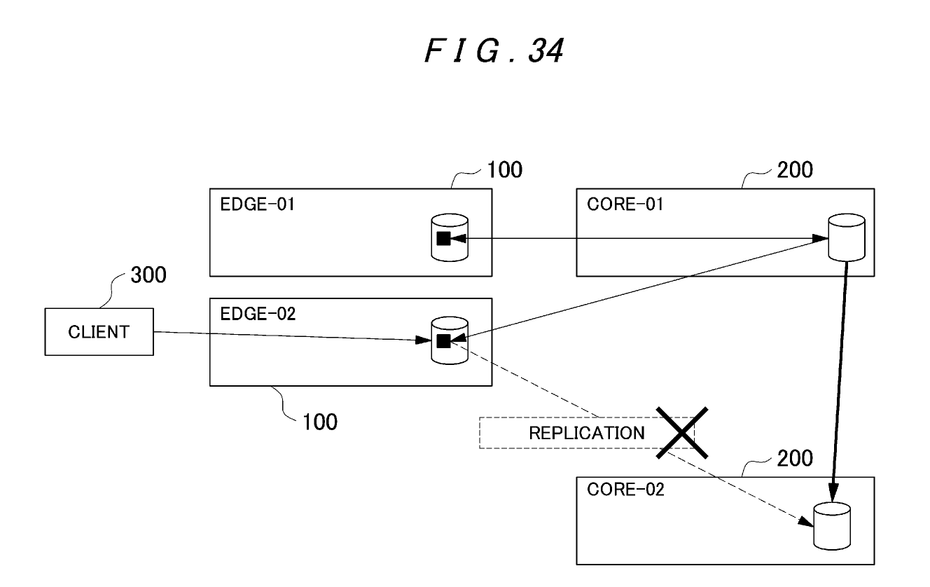

Meanwhile, this embodiment is different from the First Embodiment in that, as shown in FIG. 34, by instructing the old Core node to migrate the data to the new Core node which is newly added when the file in the storage apparatus 100 is stubbed, the data is migrated between the Core nodes.

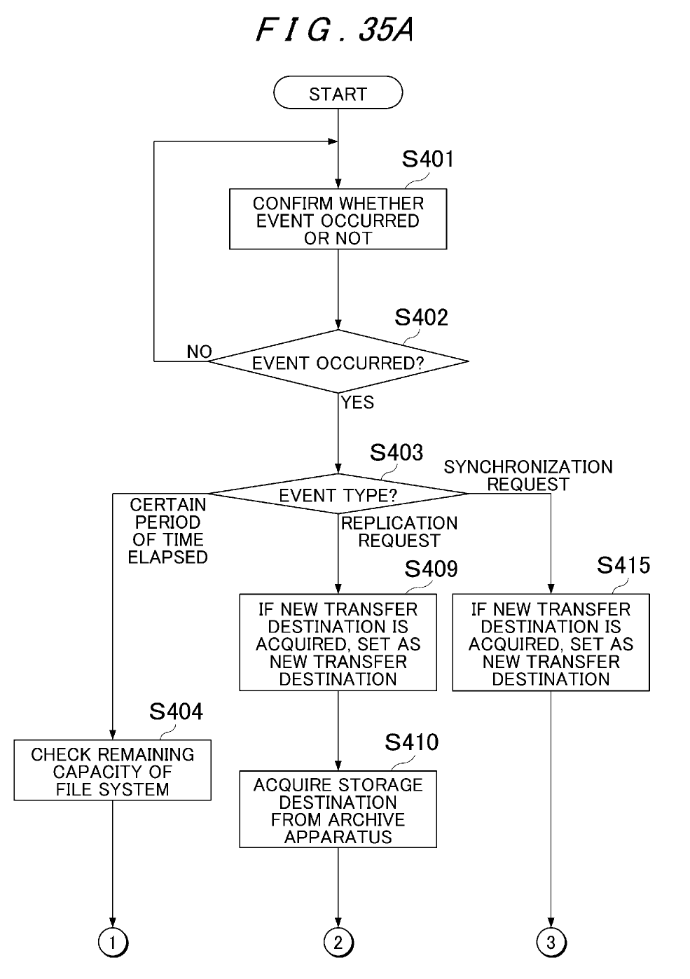

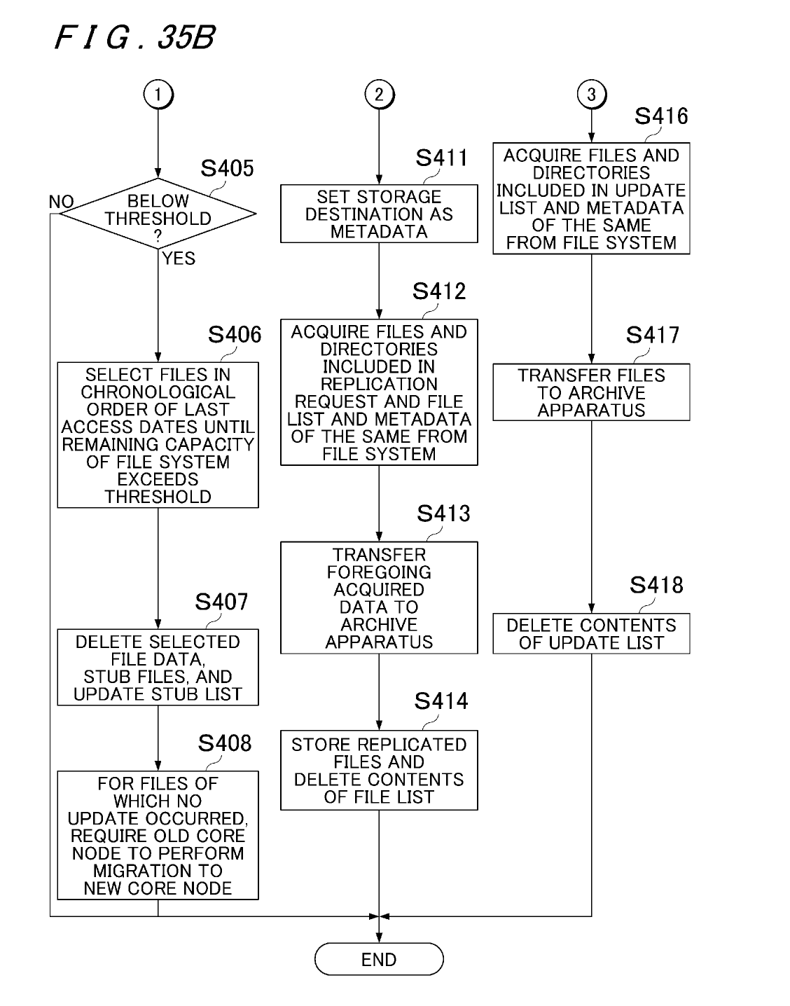

Next, the data migration processing by the data mover program 1002 of the storage apparatus 100 in which the foregoing processing is performed is explained. As shown in FIG. 35A and 35B, firstly, the data mover program 1002 confirms whether an event occurred or not (S401), and determines whether an event occurred or not (S402).

If it is determined at step S402 that an event occurred, the data mover program 1002 determines what the event type is (S403). Meanwhile, if it is not determined at step S402 that an event occurred, the data mover program 1002 repeats the processing of step S401.

Subsequently, if it is determined at step S403 that the event type is “certain period of time elapsed”, the data mover program 1002 checks the remaining capacity of the file system in the storage apparatus 100 (S404).

Subsequently, if it is determined at step S404 that the remaining capacity of the file system is below a predetermined threshold, the data mover program 1002 selects files in the chronological order of last access dates until the remaining capacity of the file system is over the threshold (S406). Specifically, the data mover program 1002 adds the capacity of the selected files to the remaining capacity of the file system, and determines whether the [total] value after the addition is over the predetermined threshold or not.

Subsequently, the data mover program 1002 deletes the file data selected at step S406, stubs the relevant files, and updates the stub list 1013 (S407). Specifically, the data mover program 1002 updates the stubbed file names, the file sizes, the stubbing dates and time (last stubbing date and time), and the number of times of stubbing in the stub list 1013. Subsequently, for the files of which no update occurred at step S407, the data mover program 1002 requires the old Core node to perform the migration to the new Core node (S408).

Meanwhile, if it is determined at step S405 that the remaining capacity of the file system is not below the predetermined threshold, [the data mover program 1002] terminates the processing.

Furthermore, if it is determined at step S403 that the event type is “replication request”, the data mover program 1002, if already acquiring the new transfer destination, sets the relevant transfer destination as the new transfer destination of the files (S409).

Subsequently, the data mover program 1002 acquires the storage destination of the file data from the transfer destination archive apparatus 200 which is set at step S409 (S410). Subsequently, the data mover program 1002 sets the storage destination of the file data acquired at step S410 in the metadata including the information of the transfer source files and the transfer destination and others (S411).

Subsequently, the data mover program 1002 acquires the files and directories included in the replication request and the file list 1011 and the metadata of the files and directories from the file system (S412). Subsequently, the data mover program 1002 transfers the data acquired at step S412 to the transfer destination archive apparatus 200 which is set at step S409 (S413). Subsequently, the data mover program 1002 stores the files transferred at step S413 as the replicated files, and deletes the contents of the file list 1011 (S414).

Furthermore, if it is determined at step S403 that the event type is “synchronization request”, the data mover program 1002, if acquiring the new transfer destination, sets the relevant transfer destination as the new transfer destination of the files (S415).

Subsequently, the data mover program 1002 acquires the files and directories stored in the update list 1012 and the metadata of the files and directories from the file system (S416). Subsequently, the data mover program 1002 transfers the files acquired at step S416 to the transfer destination archive apparatus 200 which is set at step S415 (S417). Subsequently, the data mover program 1002 deletes the contents of the update list 1012 (S418).

### (2-2) Advantageous Effects of this Embodiment

As explained above, in the computer system 2 according to this embodiment, if the entity of the data replicated to the archive apparatus 200 is deleted from the disk 115 and the data is stubbed, the migration of the foregoing data entity to a different archive apparatus 200 from the archive apparatus 200 is instructed. By this method, the data migration between the archive apparatuses 200 not via the storage apparatus 100 can be performed.

### (3) Other Embodiments

It should be noted that, though the CPU 102 of the storage apparatus 100 achieves the various types of functions of the present invention in accordance with the various types of programs stored in the storage apparatus 100 in the foregoing embodiments, [the present invention] is not limited to such examples. For example, the various types of functions may also be achieved in collaboration with the CPU of the disk array apparatus as the integrated storage apparatus of the storage apparatus 100 and the disk array apparatus 110. Furthermore, the various types of programs stored in the storage apparatus 100 may be stored in the disk array apparatus 110 and the various types of functions may be achieved by the relevant programs being called by the CPU 102.

Furthermore, for example, the respective steps in the processing by the storage apparatus 100 and others in this description do not necessarily be processed in the chronological order in accordance with the order stated as the flowcharts. Specifically, the respective steps in the processing by the storage apparatus 100 and others, even if being different types of processing, may also be performed in parallel.

Furthermore, it is also possible to create computer programs for making the hardware integrated in the storage apparatus 100 and others such as the CPU, the ROM, and the RAM exert the same functions as the respective configurations of the foregoing storage apparatus 100 and others. Furthermore, the storage media in which the relevant computer programs are stored are also provided.

### INDUSTRIAL APPLICABILITY

The present invention can be applied to the computer system which comprises a storage apparatus and an archive apparatus.

### REFERENCE SIGN LIST

1 Computer system

100 Storage apparatus

1001 File sharing program

1002 Data mover program

1003 File system

1004 Kernel/driver

1020 Monitoring program

1011 File list

1012 Update list

1013 Stub list

1014 Recall list

1015 File management table

1016 Node management table

1017 Node management table

110 Disk array apparatus

200 Archive apparatus

2001 Data mover program

2002 File system

2003 Kernel/driver

2004 Monitoring program

210 Disk array apparatus

300 Client/host

3001 Application

3002 File system

3003 Kernel/drive

1. A computer system in which a plurality of storage apparatuses, a host apparatus which requests writing of data to the plurality of storage apparatuses, and a plurality of archive apparatuses which replicate data stored in the plurality of storage apparatuses according to the request of the plurality of storage apparatuses are respectively and mutually connected via a network,
wherein the storage apparatus comprises:
a storage unit for storing data to be read and written by the host computer; and
a control unit for controlling the writing of data into the storage unit, wherein the control unit:
deletes an entity of the data replicated to the archive apparatus from the storage unit and stubs the data;
calls the stubbed data from the archive apparatus and temporarily stores the entity of the data according to a request from the host apparatus; and
if an area where the entity of the stubbed data is stored in the storage unit among data storage areas of the storage unit is a predetermined capacity or less, migrates stub information concerning the stubbed data to a storage unit of another storage apparatus.

2. The computer system according to claim 1,
wherein the storage apparatus:
creates a file system to be accessed by the host apparatus in the data storage area; and
adds a new file system according to a ratio of a capacity of the file system and a capacity of the data replicated to the archive apparatus, and migrates the stub information to the added file system.

3. The computer system according to claim 2,
wherein the storage apparatus migrates the stub information to the storage unit of the other storage apparatus when the number of times that the new file system is added exceeds a predetermined number of times and the number of times that the stubbed data is called from the archive apparatus exceeds a predetermined number of times.

4. The computer system according to claim 2,
wherein the storage unit stores a file management table which associates and manages a file path name of the file system, an apparatus name of the storage apparatus, a name of the file system, and an inode number showing a storage location of each file, and
wherein the control unit updates the file system name and the inode number of the file management table when the stub information is migrated to the added file system.

5. The computer system according to claim 4,
wherein the control unit updates the apparatus name of the storage apparatus of the file management table when the stub information is migrated to the storage unit of the other storage apparatus.

6. The computer system according to claim 3,
wherein the archive apparatus comprises:
a storage unit for storing an entity of the stubbed data; and
a control unit for controlling the writing of data into the storage unit, wherein the control unit:
transfers the entity of the stubbed data stored in the storage unit according to a request of the storage apparatus;
determines whether the entity of the data to be transferred to the storage apparatus is an update target; and
notifies information of another archive apparatus as information of the replication destination of the storage apparatus when the number of times that the update target data is transferred exceeds a predetermined number of times.

7. The computer system according to claim 6,
wherein, when information of the other archive apparatus is notified as information of the replication destination from the archive apparatus, the control unit of the storage apparatus stores the entity of the data called from the archive apparatus in the notified other archive apparatus according to a request from the host apparatus.

8. The computer system according to claim 7,
wherein the control unit of the storage apparatus compares information of the date and time that the other archive apparatus was added and information of the date and time that the data was called according to a request from the host apparatus, and stores the data as a replication target in the storage unit when the data is called after the other archive apparatus has been added.

9. The computer system according to claim 7,
wherein, upon deleting the entity of the data replicated to the archive apparatus from the storage unit and stubbing the data, the control unit of the storage apparatus commands an archive apparatus that is different from the archive apparatus to migrate the entity of the data.

10. The computer system according to claim 6,
wherein the control unit of the archive apparatus controls whether to notify information of the other archive apparatus as information of the replication destination of the storage apparatus when the number of times that the update target data is transferred exceeds a predetermined number of times according to a combination of the apparatus name of the storage apparatus and the apparatus name of the archive apparatus.

11. The computer system according to claim 6,
wherein the control unit of the archive apparatus detects a change in a policy including a criterion for stubbing the data, and controls whether to notify information of the other archive apparatus as information of the replication destination of the storage apparatus according to the changed contents of the policy.

12. A data management method using a computer system in which a plurality of storage apparatuses, a host apparatus which requests writing of data to the plurality of storage apparatuses, and a plurality of archive apparatuses which replicate data stored in the plurality of storage apparatuses according to the request of the plurality of storage apparatuses are respectively and mutually connected via a network, wherein the storage apparatus comprises:
a storage unit for storing data to be read and written by the host computer; and
a control unit for controlling the writing of data into the storage unit, wherein the control unit comprises:
a first step of deleting an entity of the data replicated to the archive apparatus from the storage unit and stubbing the data;
a second step of calling the stubbed data from the archive apparatus and temporarily storing the entity of the data according to a request from the host apparatus; and
a third step of migrating, if an area where the entity of the stubbed data is stored in the storage unit among data storage areas of the storage unit is a predetermined capacity or less, stub information concerning the stubbed data to a storage unit of another storage apparatus.
